(19) United States
(12) Patent Application Publication
(10) Pub. No.: US 2003/0027708 A1
(43) Pub. Date: Feb. 6, 2003

(54) Novel clay and products

(76) Inventors: Michael Ginn, Sandersville, GA (US); Peter Akerley, Nova Scotia (CA)

Correspondence Address: Harold H. Flanders, 904 Sweetwater Cove, Round Rock, TX, 78681, US

(21) Appl. No.: 09/908,426

(22) Filed: Jul. 18, 2001

(51) Int. Cl. C04B 33/04; C04B 14/10; C04B 14/12; D21H 17/68

(52) U.S. Cl. 501/141; 423/328.1; 106/484; 106/486; 162/180

(57) ABSTRACT

A method of exploring for a primary kaolin and producing products therefrom.

### BACKGROUND OF THE INVENTION

1. Field of the Invention

The present invention relates generally to clays and more particularly to a new and novel clay, and an improved method for prospecting for, locating, identifying, defining, and beneficiation of the novel clay and for such other methods as may be herein disclosed.

### RELEVANT STATE OF THE ART AND DESCRIPTION OF RELATED PRIOR ART

The term “clay” is not totally unambiguous. It sometimes refers to a type of material or soil. The term “clay” is sometimes said to refer to a physical condition and not to a definite chemical composition. In general, clay is plastic when wet and may be rendered hard by firing.

“Clay” is sometimes defined as a disperse system of mineral fragments of hydrated aluminum silicate in which particles smaller than two (2) microns predominate.

“Residual” or “Primary” clays are those found at their original points of formation.

“Sedimentary” or “secondary” clays are those which have been transported by wind or water or a combination of such forces from their original points of formation and deposited elsewhere.

“Kaolin” or “China Clay” may be defined as a white clay derived by decomposition and weathering of an aluminous mineral, such as feldspar, mica and the like. It is sometimes more specifically defined as being formed by the decomposition of the feldspars in granite.

Kaolin, when the term is used properly, refers to a material composed predominately of kaolinite. Sometimes clays such as the indianaite of Indiana or the halloysite of Alabama have been termed as kaolins, but are largely, if not almost entirely, composed of hydrous aluminum silicates other than kaolinite.

“Kaolinite” is a hydrated aluminum silicate mineral of definite chemical composition, usually occurring in the form of very small crystals.

Its composition can be, and often is, arbitrarily written in the form:

2H₂O.Al₂O₃.2SiO₂,

It is now well-known that kaolinite is an aluminum hydroxide silicate of approximate composition:

Al₂(OH)₄S₂O₅,

and it may be written in a number of different forms such as:

[Al₂(Si₂O₅)(OH)₄]

or

H₄Al₂Si₂O₉.

The formation of clay by weathering and decomposition of feldspar and other alumina-silica rocks may take place in several different ways:

1) by decomposition of silicate minerals;

2) by solution of carbonate components of rocks containing insoluble clay impurities which are left behind as an insoluble residue;

3) by disintegration, accompanied by some solution of shales; and

4) by similar processes.

The formation of mica, quartz and kaolinite from feldspar may proceed along the following lines:

1) feldspar (KAlSi₃O₈) in contact with water and carbon dioxide may yield mica (KH₂Al₃Si₃O₁₂), silica and potassium carbonate;

2) mica may further disintegrate into leucite, alumina, silica and water;

3) feldspar in contact with water and carbon dioxide may also yield kaolinite directly along with silica and potassium carbonate; and

4) many other reactions which may be favored under specific conditions of concentration, temperature, pressure, pH and other factors.

The sedimentary deposits of Georgia and South Carolina furnish approximately 90% of the kaolin produced in the United States. These deposits occur in an irregular belt, stretching diagonally across the middle of the State of Georgia and protruding into South Carolina in the region of Aiken County, South Carolina. This belt is commonly known as the “Fall Line”.

The “Fall Line” has been known as a well established entity and a recognized geological term for a long number of years, see Millman, Nate, Kaolin Clays and Their Industrial Uses, (J. M. Huber Corp. copyright 1955); Henry and Vaughn, American Institute of Mining and Metallurgical Engineers, Technical Bulletin No. 774 (January 1937); Mitchell and Henry, The Journal of the American Ceramic Society, Vol. 26, No. 4, pp.105-113 (April, 1943).

The source material of the Fall Line originated from the feldspathic rocks of the Piedmont Plateau, a region to the north of the present Fall Line, in what are now the Piedmont and Highland sections of Georgia and the adjoining states.

The sedimentary clays along the Fall Line have typically been processed or beneficiated by a series of unit operations such as comminution, crushing, screening, grinding, leaching, flotation, selective or differential flocculation or sedimentation, classification, and magnetic and other separations. Once beneficiated the sedimentary clays are then sold across the nation for use in ceramics, paper, paint, rubber, plastics, cosmetics, home care products, catalysis, and the like.

While the sedimentary clays of the Georgia-South Carolina region have found massive commercial acceptance, the primary clays of the southeastern United States have found limited or no commercial applications. This fact may in part relate to the lack of a method for prospecting for and identifying suitable deposits prior to the present invention. Another factor is no doubt the fact that most of the known deposits are heavily discolored with red or yellow impurities.

As background for the disclosure to follow, it will develop that the present invention makes possible the large scale commercial production from primary feed materials of high brightness, calcined and non-calcined products, delaminated and non-delaminated products as well as products to which some degree of structure may have been added by one means or another. The following discussion is intended to provide a brief background to some of these products and a basis for certain features of their disclosure.

In the course of manufacturing paper and similar products, including paper board and the like, it is common and well known to incorporate quantities of inorganic materials into the fibrous web in order to improve the quality of the resulting product. A number of inorganic materials, such as titanium dioxide, have long been known to be effective for these purposes. These materials can be incorporated into the paper in the from of anatase or rutile. Titanium dioxide, however, is among the most expensive materials which can be used. Accordingly, in recent years, considerable efforts have been made to develop satisfactory replacements for the titanium dioxide.

Titanium dioxide is recognized as providing the maximum brightness and opacity development of all commercially available pigment. However, it is also the most expensive commercially available pigment. As a result, paper and paint manufacturers are continually looking for means to optimize their use of expensive titanium dioxide while still achieving their quality targets. Based on their superior optical properties, calcined kaolins have proven to be very effective titanium dioxide extenders and have enjoyed wide acceptance in the paper, paint, and plastics industries. Among the materials which have found increasing acceptance as paper fillers are substantially anhydrous kaolin clays. Materials of this type are generally prepared by partially or fully calcining a crude kaolin clay, which may have been subjected to prior beneficiation steps in order to remove certain impurities (e.g. for the purpose of improving brightness in the ultimate product). It is important to recognize that those skilled in the art of kaolin processing draw a sharp and fundamental distinction between calcined and uncalcined kaolins.

With respect to terminology, it is noted that the prior art literature, including numerous prior art patents relating to the field of kaolin products and processing, often uses the term “hydrous” to refer to a kaolin which has not been subjected to calcination—more specifically, one that has not been heated to temperatures above about 450 Degrees C. Such temperatures serve to alter the basic crystal structure of kaolin. These so-called “hydrous” clays may have been produced from crude kaolins, which have been subjected to various operations of beneficiation (for example: froth flotation, magnetic separation, mechanical delamination, grinding, or comminution), but not to such heating as would impair the crystal structure.

In an accurate technical sense, the description of these materials as “hydrous” is, however, incorrect. More specifically, there is no molecular water actually present in the kaolinite structure. Thus, although the composition can be, and often is, arbitrarily written in the form:

2H₂O.Al₂O₃.2SiO₂,

it is now well-known that kaolinite is an aluminum hydroxide silicate.

Once the kaolin is subjected to calcination, which, for the purposes of this specification means being subjected to heating of 450 Degrees C. or higher for a period which eliminates the hydroxyl groups, the crystalline structure of the kaolinite is destroyed. As used in this specification, the term “calcined kaolin” shall refer to such kaolin. Preferably the calcined kaolin has been heated above the 980 Degree C. exotherm, and therefore is “fully calcined”, as opposed to having been rendered merely a “metakaolin”.

Reference may be had in the forgoing connection to Proctor: U.S. Pat. No. 3,014,836 and to Fanselow et al: U.S. Pat. No. 3,586,823, which disclosures are representative of portions of the prior art pertinent to fully calcined kaolins. A common calcined product is described in U.S. Pat. No. 4,381,948 to McConnell et al.

In the present invention, mined kaolin may be initially subjected to processes which are generally well known in the art of clay processing as unit operations, per se, and which are intended to remove undesired impurities from the clay. One such process is a dry processing technique, known as air flotation processing. Wet processing techniques of various types can also be employed such as the well known techniques of froth flotation, reductive and oxidative bleaching, and high intensity magnetic separation. The kaolin may be dried such as by spray drying or by other means. These processes are all well known in the art. See for example, U.S. Pat. No. 5,213,687 to Ginn et al. Detailed discussions of calcined clays and their methods of preparation can be found in numerous prior art patents. For example, see U.S. Pat. Nos. 5,223,155 to Ginn et al.; 3,014,836 to Proctor, Jr.; 3,586,523 to Fanselow et al.; 4,381,948 to McConnell et al. and 5,022,924 to Raythatha et al,; the disclosures of which are incorporated herein by reference.

Reference to the known patent literature may be had for the details of the general processing of kaolins and for such processes as may relate to delamination and the like. For example, see Millman el al, British Patent 1,050,143 bases on a 1963 filing; Gunn and Morris U.S. Pat. No. 3,171,718 which discloses a product with a 99 calcined brightness; Cohn el al U.S. Pat. No. 3,253,791 teaches a homogenizing extrusion delamination; Billue U.S. Pat. No. 3,343,973; Lyons U.S. 3,324,208; Morris et al U.S. Pat. No. 3,519,453; Lyons U.S. Pat. No. 3,528,769; Walsh et al U.S. Pat. No. 3,615,806 and Iannicelli 3,667,688; Abercrombie et al U.S. Pat. Nos. 3,798,044 and 3,743,190.

Classification techniques are taught by Lyons U.S. Pat. No. 3,727,831 and Clark et al U.S. Pat. No. 3,868,318.

Grinding techniques are taught by Helton and Davis in U.S. Pat. No. 3,536,264. Dille et al U.S. Pat. No. 3,643,875; Clark U.S. Pat. No. 3,817,457; Chapman et al U.S. Pat. No. 3,924,813; Brociner U.S. Pat. No. 3,464,634.

Flotation is taught in Allegrini et al U.S. Pat. No. 3,503,499; Cooper U.S. Pat. No. 3,551,897; Nallary et al U.S. Pat. No. 3,861,934; Iannicelli U.S. Pat. No. 3,224,582; Mercade U.S. Pat. No. 3,337,048; Duke U.S. Pat. No. 3,425, 546; and Mercade U.S. Pat. No. 3,462,013.

Mangnetic separation techniques are taught by Windle et al British Pat. 1,004,570; Weston U.S. Pat. No. 3,289,836 and 3,294,237; Malden et al British Pat 1,077,242; Iannicelli et al U.S. Pat. No. 3,471,011; Stone Canadian Pat. 758,881; Malden et al U.S. Pat. No. 3,482,685; Aubrey et al U.S. Pat. No. 3,608,718; Allen U.S. Pat. Nos. 3,819,515; Girard 2,329,893; Daniels 2,407,539; Frantz 2,074,085; Kison 2,490,635; Braunlick 2,784,843; Jones 2,786,047 and 3,346,116; Marston 3,627,678; and Kolm 3,567,026. Other related patents are U.S. Pat. Nos. 2,231,769; 2,430,157; 3,667,689; 3,676,337; 3,770,629; 3,961,971; 3,985,646; 4,005,008; 4,087,358; 4,147,632; 4,157,954; 4,281,799; 4,356,093; 4,424,124; 4,680,936;4,694,269; 5,019,247; 5,047,375; 5,148,137; 5,237,738; 5,495,718; and 5,697,220.

Since kaolin is a natural product, its composition is subject to routine variations, and the entire disclosure herein is subject to routine variations, depending on the starting material.

Here follows a brief description of some of the tests to which reference will be made in discussing some of the properties of the products of the present invention.

The term or acronym “TAPPI” refers to various standards and publications of the Technical Association of the Pulp and Paper Industry.

Brightness is measured by a well-known instrument made by the General Electric Company. The value of brightness, as measured by such an instrument, is conventionally designated as the “G.E. Brightness” value. The brightness of magnesium oxide, MgO, is given a value of 100. Other brightnesses are described as a percentage of the brightness of MgO. TAPPI Procedure T-646-os-75 is followed in making this measurement. All brightness values of minerals and fillers as used herein refer to block brightness values as determined in accordance with the above cited TAPPI standard procedures with a G.E. reflectance meter using light having a wavelength of about 457 nanometers or with comparable equipment and techniques. Paper brightness was measured in accordance with the Canadian Pulp and Paper Association Standard Method E.J.

Diffuse opacity was measured in accordance with TAPPI Standard Method T 519 om 86. Reflectance backing opacity was measured in accordance with TAPPI Standard Method T 425 om 86.

Both the brightness characteristics of a given kaolin and the opacifying properties of the same when incorporated as a filler in paper, may be quantitatively related to a property of the filler identified as the “scattering coefficient, S”. The scattering coefficient, S, of a given filler pigment is a property well known and extensively utilized in the paper technologies and art and has been the subject of numerous technical papers. An early exposition of such measurements was made by Kubelka and Munk, and is reported in Z. Tech Physik 12:539(1931). Further citations to the applicable measurement techniques and detailed definitions of the said scattering coefficient are set forth at numerous places in the patent and technical literature. Reference may usefully be had in this connection to U.S. Pat. Nos. 4,026,762 and 4,028,173. In addition reference may further be had to Pulp and Paper Science Technology, Vol. 2 “Paper” Chapter 3, by H. C. Schwalbe (McGraw-Hill Book Company, New York).

Abrasion may be measured by the well-known Valley Abrasion test method described in the Institute of Paper Chemistry Procedure 65 and as described in U.S. Pat. No. 3,014,836 to Proctor. It may also be measured by the Breunig Abrasion test as set forth in U.S. Pat. No. 4,678,517 to Dunaway or by the Einlehner Abrasion Test as set forth in U.S. Pat. No. 5,011,534 to Berube et al. In general the measurements reported herein have been made in accordance with TAPPI Standard Abrasion techniques at 47,500 revolutions and at 10% solids.

Oil Absorption may be measured as set forth in ASTM D281-31.

Bulk density is measured as described in U.S. Pat. No. 4,693,427 to Billmoria et al.

Particle size may be determined by sedimentation methods as published by the Technical Association of the Pulp and Paper Industry as T 649 cm-90, entitled Particle-Size Distribution of Coating Clay. Other known methods may be used as well.

“Strike-through” is defined as 100 minus the ratio (expressed as a percent) of the reflectance of the back of the printed area to the reflectance of the unprinted sheet while both are backed by a black body.

Other standard and TAPPI test methods which may be employed are as follows:

Ash:

T244 om-93(acid insoluble)

T 211 om-93(@ 525 C)

T 413 om-93(@ 900C)

Brightness:

T 560 om-96 paper(whiteness d/0)

T 562 om 93 paper(whiteness 45/0)

T 646 om-94 clay (45/0)

T534 pm-92 clay (d/0)

T 452 om-92 pulp, paper (457 um)

Scatter:

F 10

T 220 sp-96

T425 om-91

Absorption:

TIS 0804-02

TIS 0804-03

Opacity:

T 519 om-96 (d/0)

T425 om-91 (15/d, 89% reflectance)

Hunter L, lightness: 0,black; 100, white

a, red+, green−, 0, grey

b, yellow+, blue−, 0, grey

T 524 om-94 (45/0)

T 527 om-94

Caliper, thickness:

T411 om-89

Bulk, specific volume:

T 220 sp-96

Gurley Porosity, air resistance of paper:

T 460 om-90

T 536 om-96

Burst, ratio:

T 403 om-91

T 220 sp-96 (pulp handsheet)

Formation:

T 205 sp-95 (physical)

T 272 om-92 (reflectance)

Paint and related test were performed in accordance with the following ASTM methods:

| | |
|---|---|
| Fineness of Grind | D 1210 |
| Viscosity-Stormer | D 562 |
| pH | E 70 |
| Reflectance | B 1347 |
| Sheen/Gloss | D 523 |
| Hiding Power | D 2805 |
| Scrub Resistance | D 2486 (0.98 contact ratio) |

The following TAPPI Test Methods are also commonly employed in connection with paper and other routine testing:

| | |
|---|---|
| Ash content | T 413 |
| Brightness | T 452 |
| Gloss | T 480 |
| L, a, b | T 524 |
| Opacity | T 425 |
| PPS Roughness | T 555 |
| IGT | T 514 |

### BRIEF SUMMARY OF THE INVENTION

The present invention relates to methods of prospecting for and identifying commercial, high quality primary clays and to the wide range of products which may be produced therefrom.

### OBJECTS

Pursuant to the foregoing, it may be regarded as an object of the present invention to overcome the deficiencies of and provide for improvements in the state of the prior art as described above and as may be known to those skilled in the art.

It is a further object of the present invention to provide a process and apparatus of the forgoing character and in accordance with the above objects which may be readily carried out with comparatively simple equipment and with relatively simple engineering requirements.

Still further objects may be recognized and become apparent upon consideration of the following specification, taken as a whole, in conjunction with the appended drawings and claims, wherein by way of illustration and example, an embodiment of the present invention is disclosed.

The above and other objects of the present invention are realized and the limitations of the prior art are overcome by providing a new source of commercially significant primary clay and a new group of products which may be made from such clays.

### TECHNICAL PROBLEMS TO BE SOLVED

The existence of primary clay deposits along the Fall Line in Georgia-South Carolina has, of course, long been known, but it has heretofore not been known how to locate commercially significant deposits which may be turned into high brightness kaolin products.

### UTILITY

The present invention makes available for commercial use significant deposits of primary clays which had previously been only marginally defined and it makes possible the production of high brightness, delaminated and calcined products from these deposits. These products find utility in the paper, paint, ceramics, rubber, plastics, cosmetics, home product, and chemical industries along with other uses.

BRIEF DESCRIPTION OF THE DRAWINGS

The above mentioned and other objects and advantages of the present invention and a better understanding of the principles and details of the present invention will be evident from the following description taken in conjunction with the appended drawings.

The drawings constitute a part of this specification and include exemplary embodiments of the present invention, which may be embodied in various forms. It is to be understood that in some instances various aspects of the invention may be shown exaggerated, reduced or enlarged, and schematically or otherwise distorted to facilitate an understanding of the present invention.

While some effort has been made to refer to the same apparatus or step with the same reference numerals throughout the application. It has not been considered desirable to do so in all situations. Further, the use of the same letter designation (A, B, C, . . . ) to refer to a sample in different examples should not be taken to imply, suggest, connote or denote that the samples are the same or similar except as the specific example may specifically designate the identity, if any.

In the drawings appended hereto:

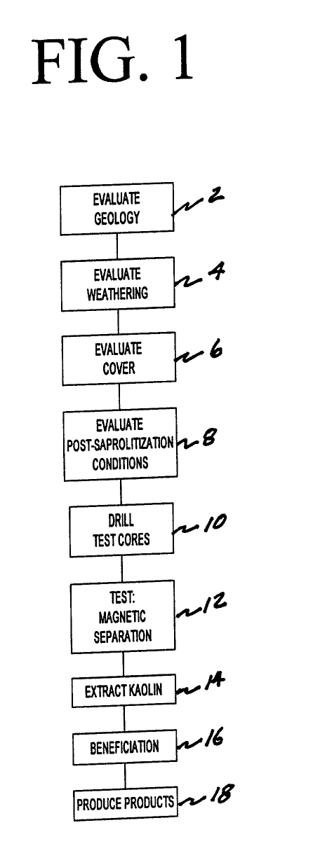

FIG. 1 is a flow sheet of the exploration scheme of the present invention.

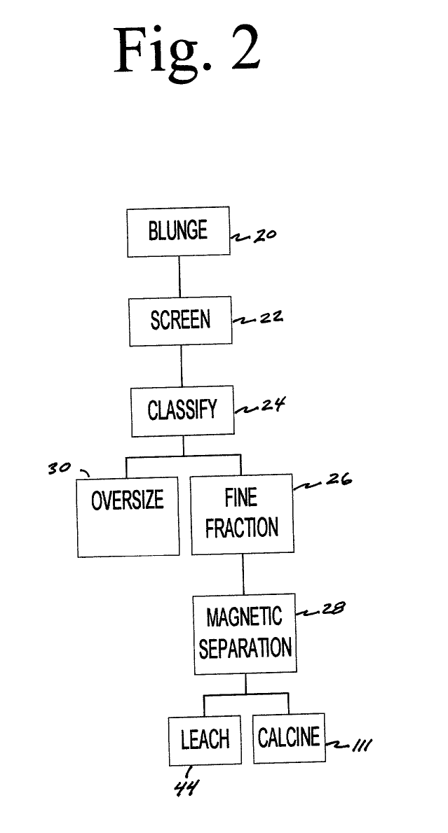

FIG. 2 is a flow sheet of one of the processes of the present invention as described in Example 1.

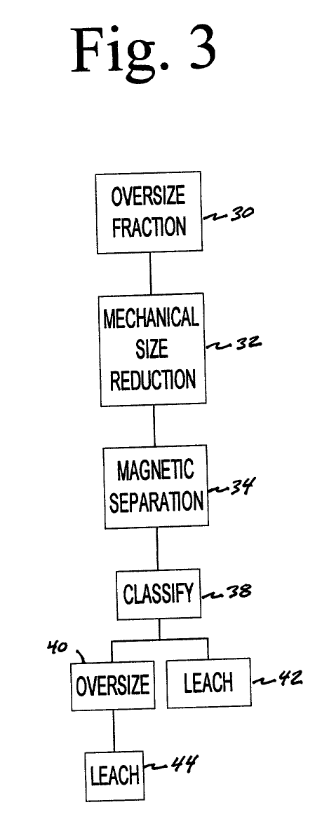

FIG. 3 is a flow sheet of one of the processes of the present invention as described in Example 2.

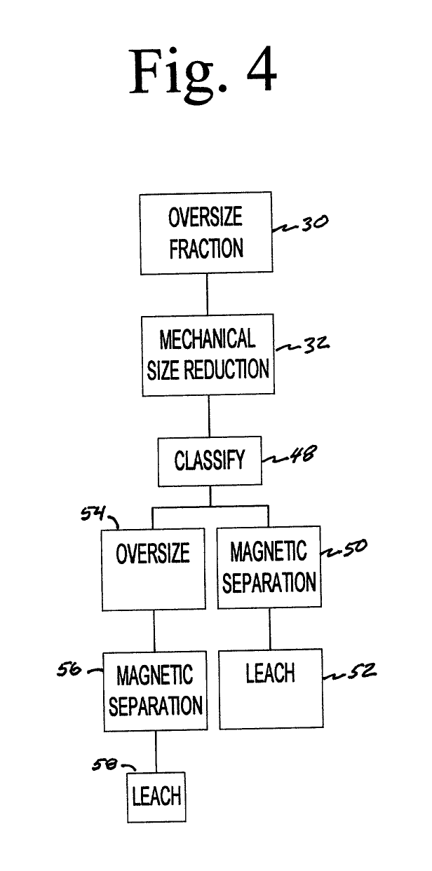

FIG. 4 is a flow sheet of one of the processes of the present invention as described in Example 3.

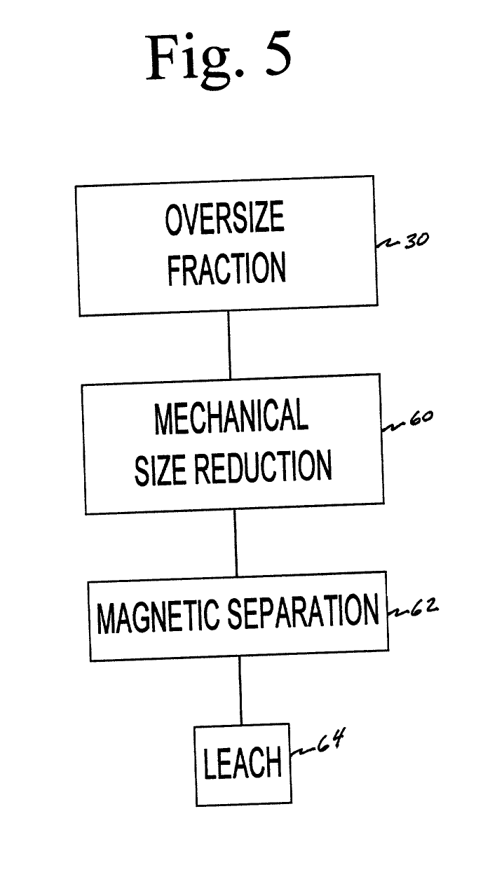

FIG. 5 is a flow sheet of one of the processes of the present invention as described in Example 6.

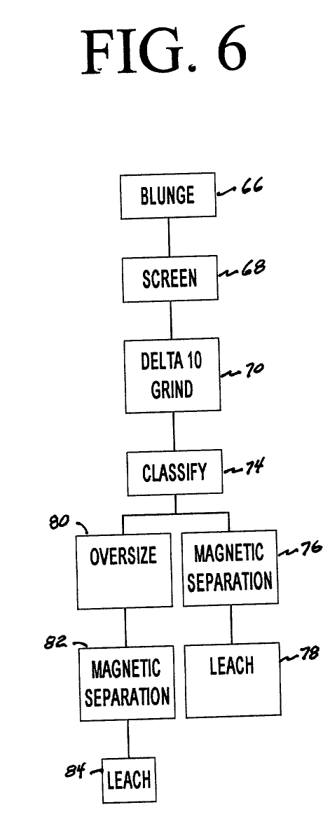

FIG. 6 is a flow sheet of one of the processes of the present invention as described in Example 7.

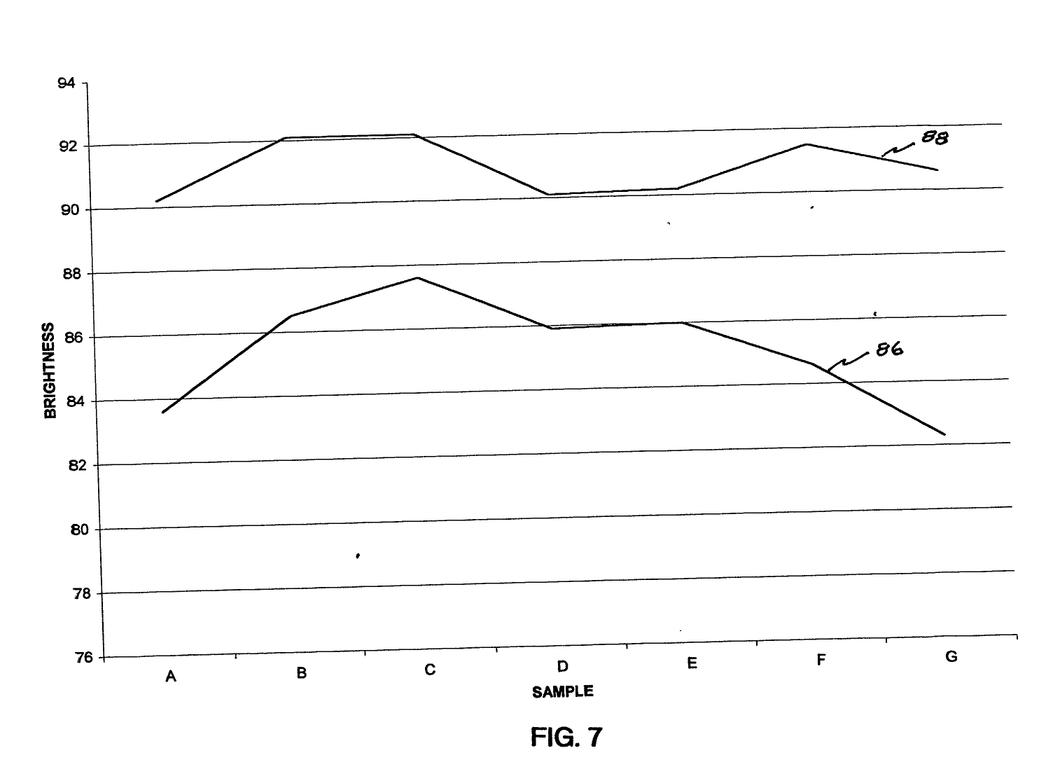

FIG. 7 is a pair of curves showing the brightness of specified samples set forth in Example 11.

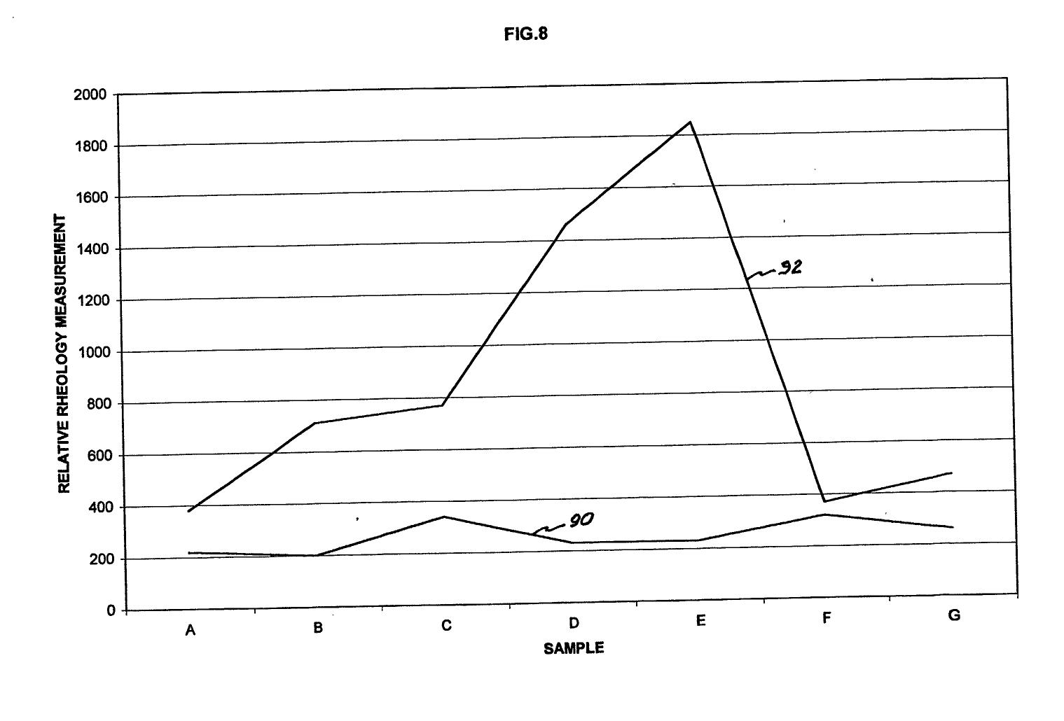

FIG. 8 is a pair of curves showing the High Shear or Hercules viscosity and the Low Shear or Brookfield viscosity of specified samples set forth in Example 11.

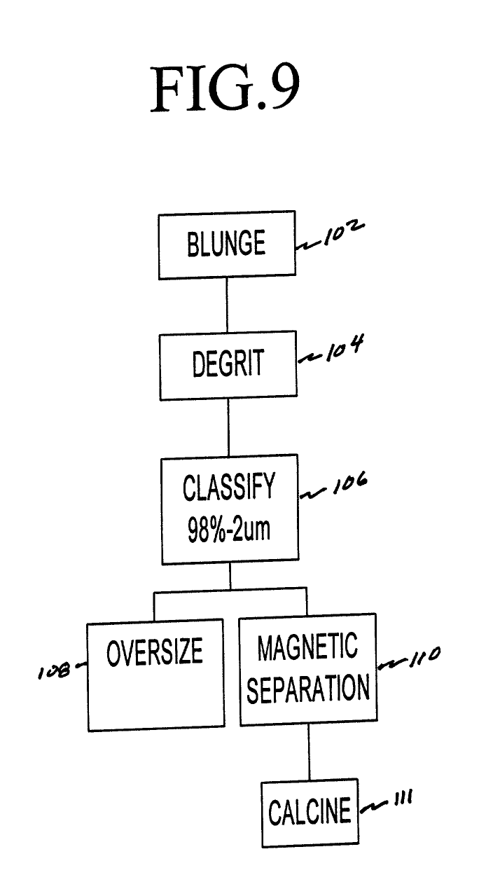

FIG. 9 is a flow sheet of one of the processes of the present invention as described in Example 12.

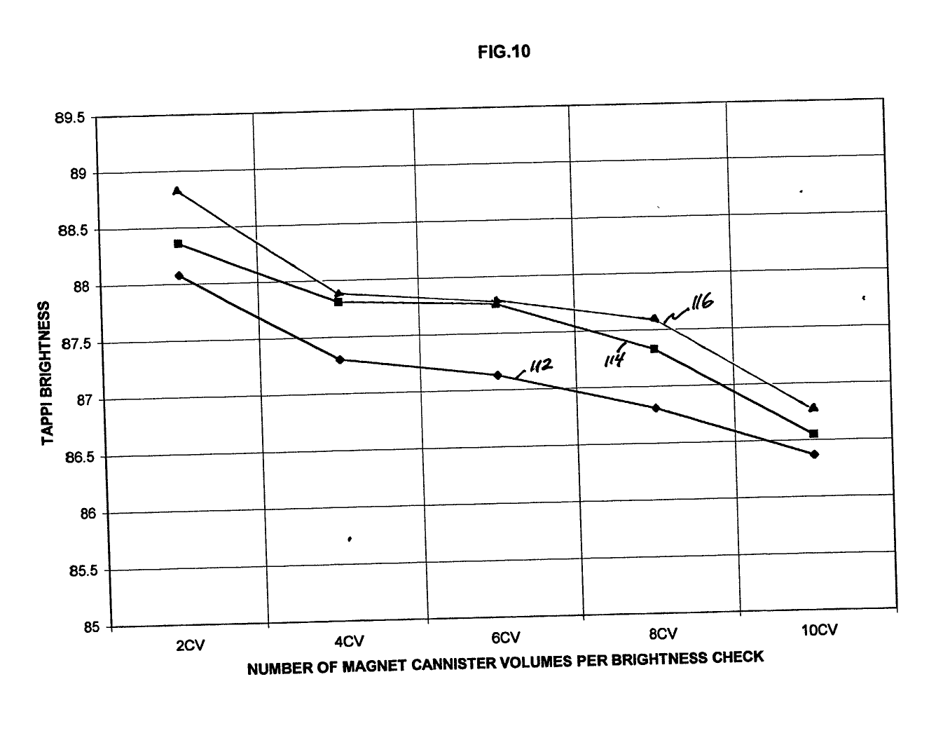

FIG. 10 is a plot of TAPPI Brightness as a function of the number of magnet cannister volumes per brightness check at three different flow rates under the conditions of Example 12.

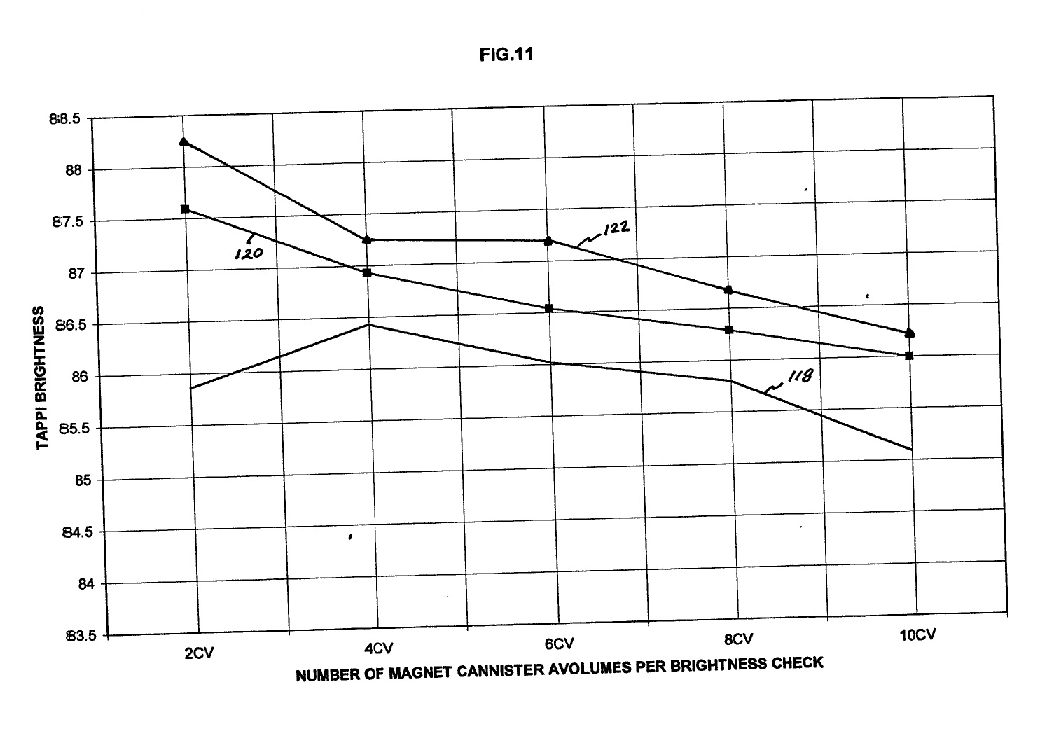

FIG. 11 is a plot of the TAPPI Brightness as a function of the number of magnet cannister volumes per brightness check at three different flow rates under the conditions of Example 13.

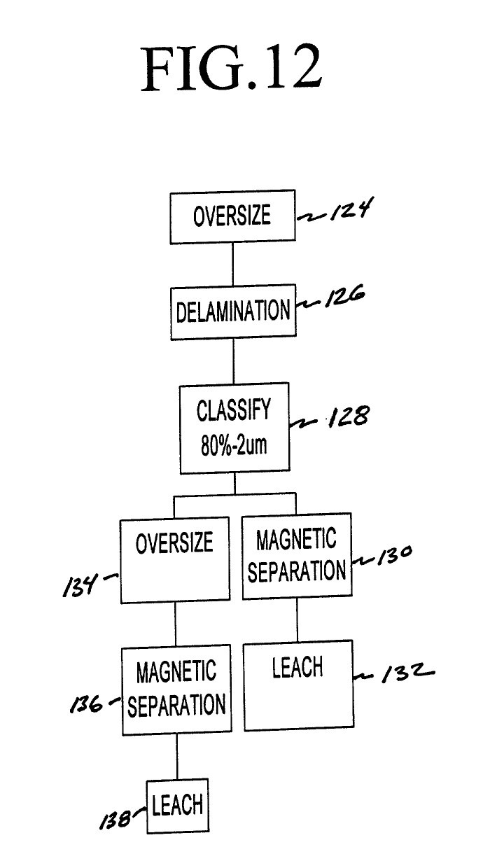

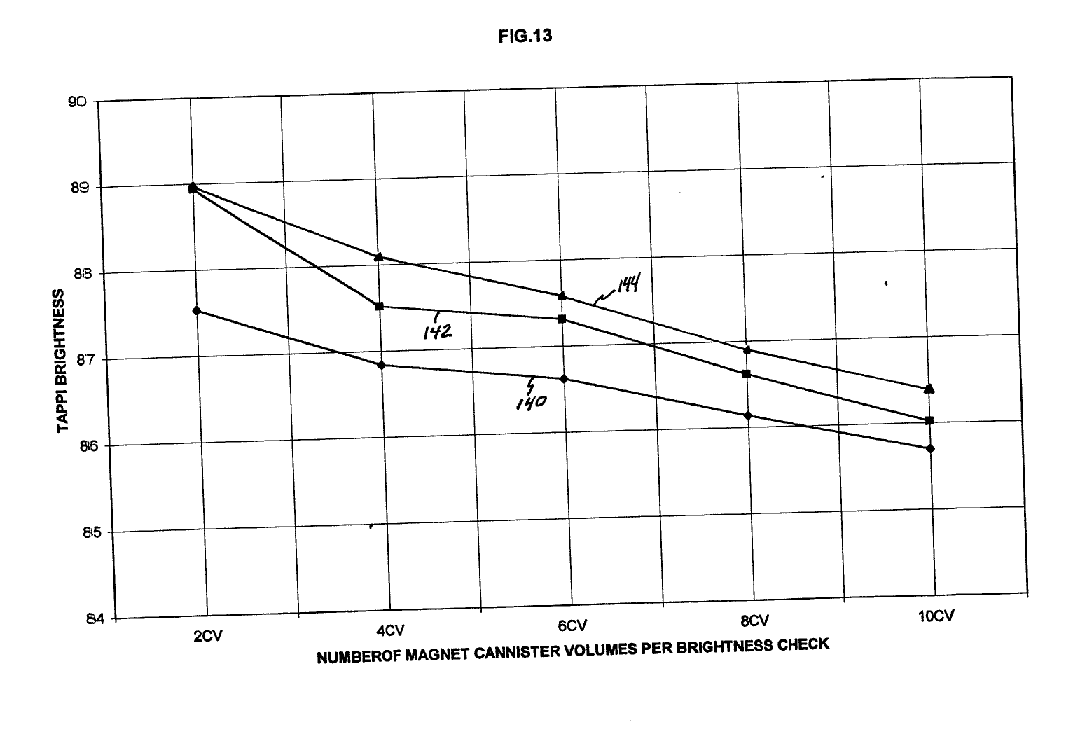

FIG. 12 is a flow sheet of one of the processes of the present invention as described in Example 14. FIG. 13 shows the TAPPI Brightness as a function of the number of magnetic cannister volumes per brightness checks at three different flow rates as set forth in Example 14.

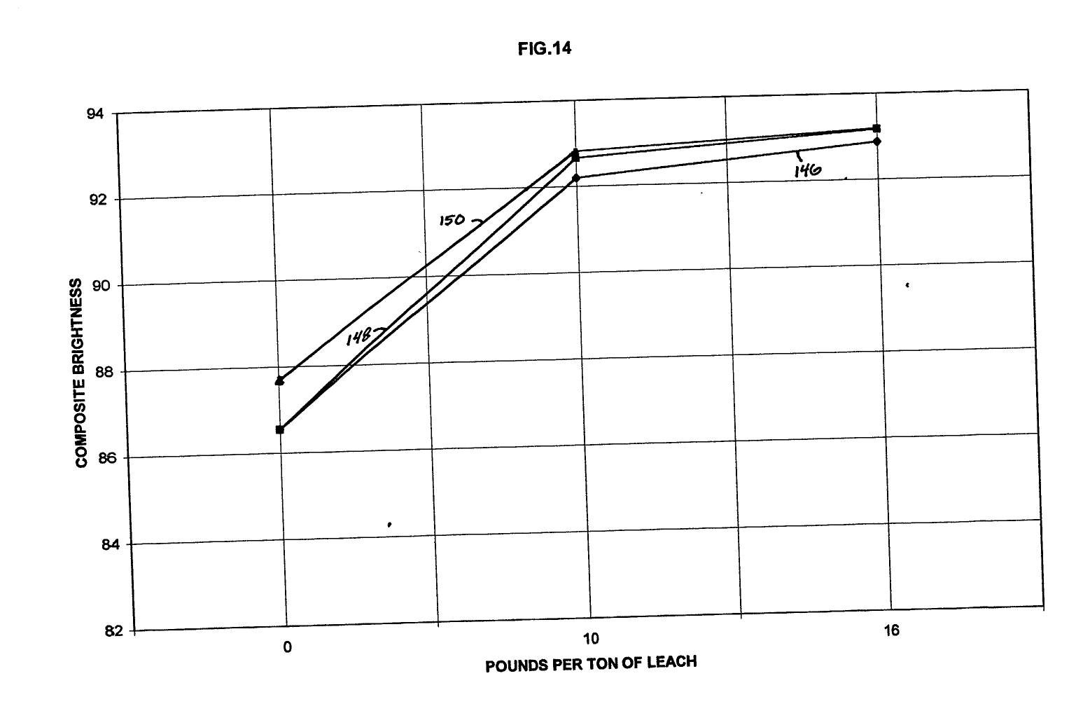

FIG. 14 shows a composite brightness as a function of leach dose on a delaminated clay passed through a magnetic separator.

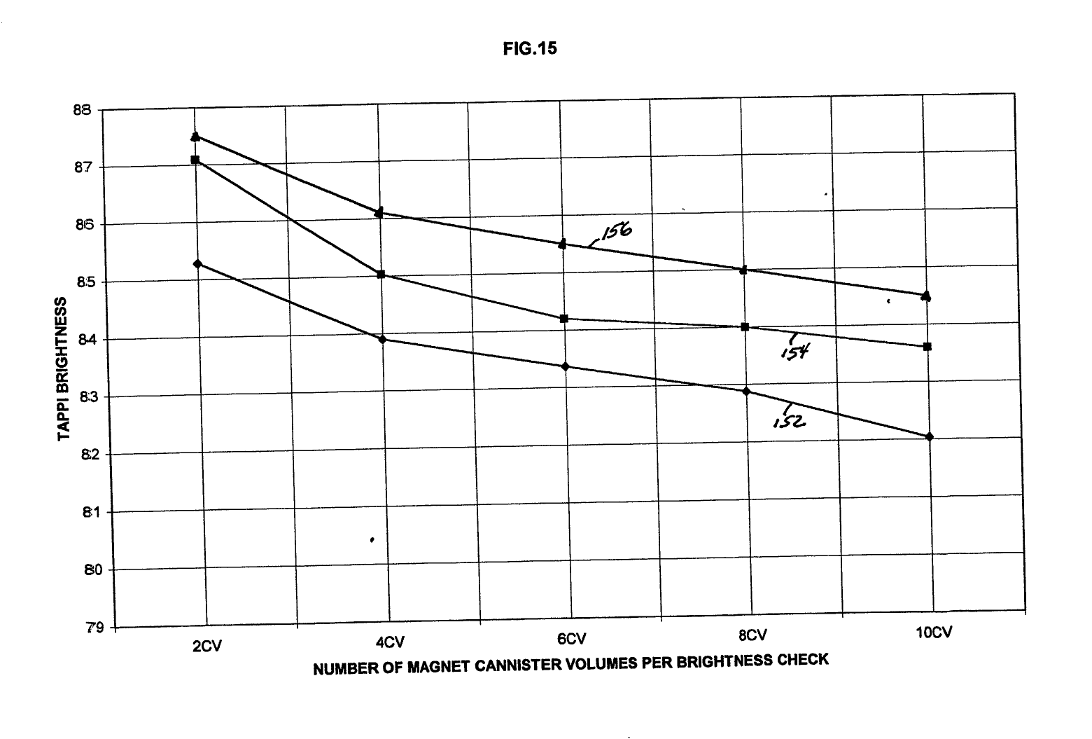

FIG. 15 shows the TAPPI Brightness as a function of the number of magnet cannister volumes per brightness check for a filler clay magnet feed (41%-2 um) at 4% matrix packing density.

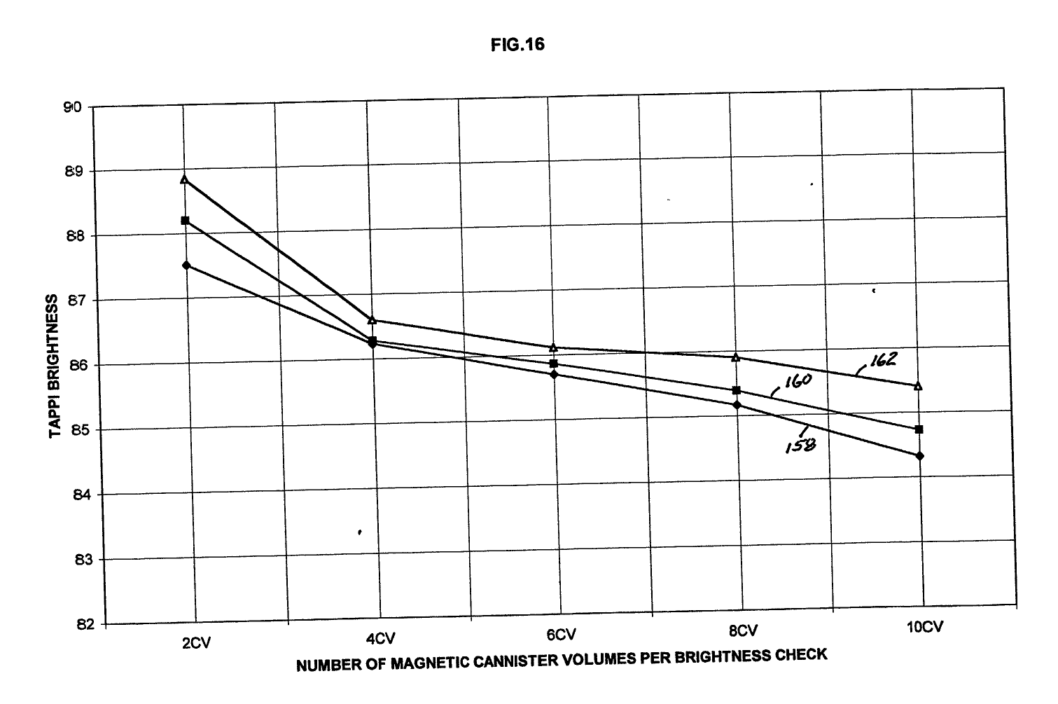

FIG. 16 shows the TAPPI Brightness as a function of the number of magnet cannister volumes per brightness check for a filler clay magnet feed (41%-2 um) at 6% matrix packing density.

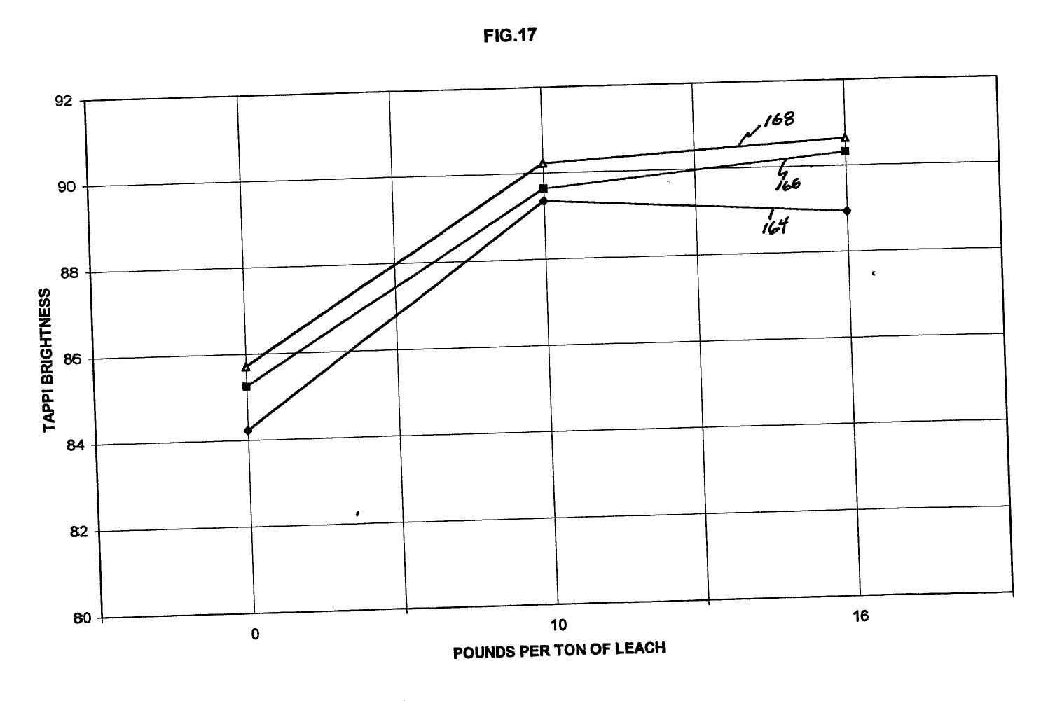

FIG. 17 shows the composite brightness after magnetic separation with a 4% packing density of a filler clay which was then leached as a function of leach dosage.

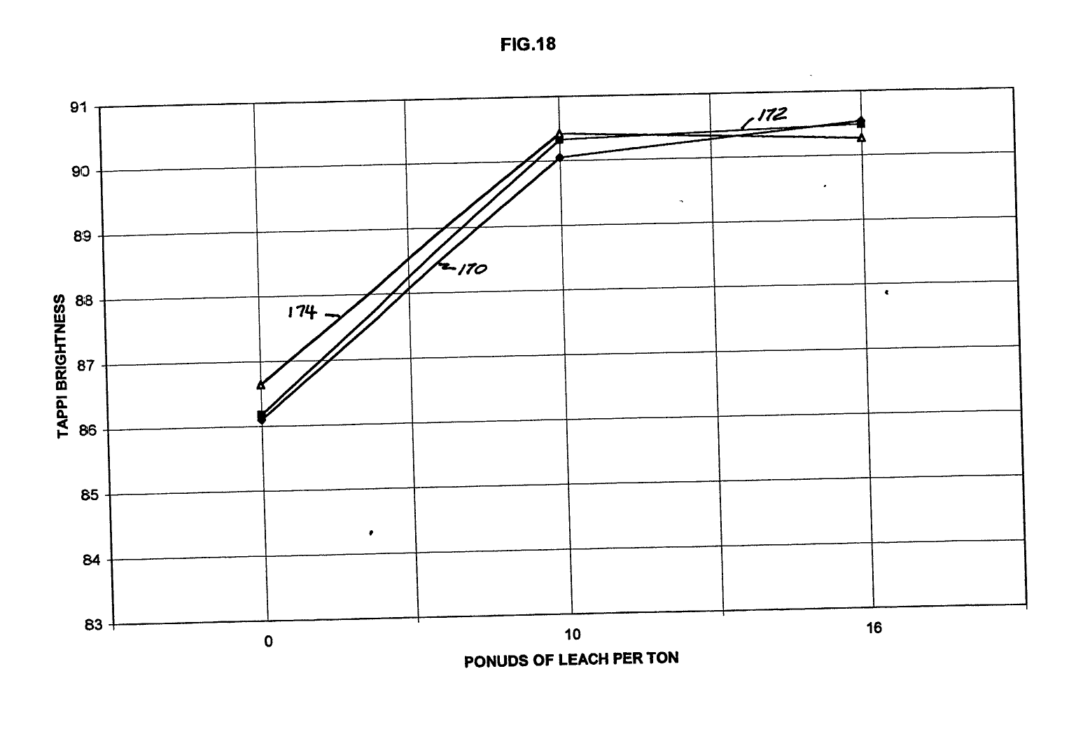

FIG. 18 shows the composite brightness after magnetic separation with a 6% packing density of a filler clay which was then leached as a function of leach dosage.

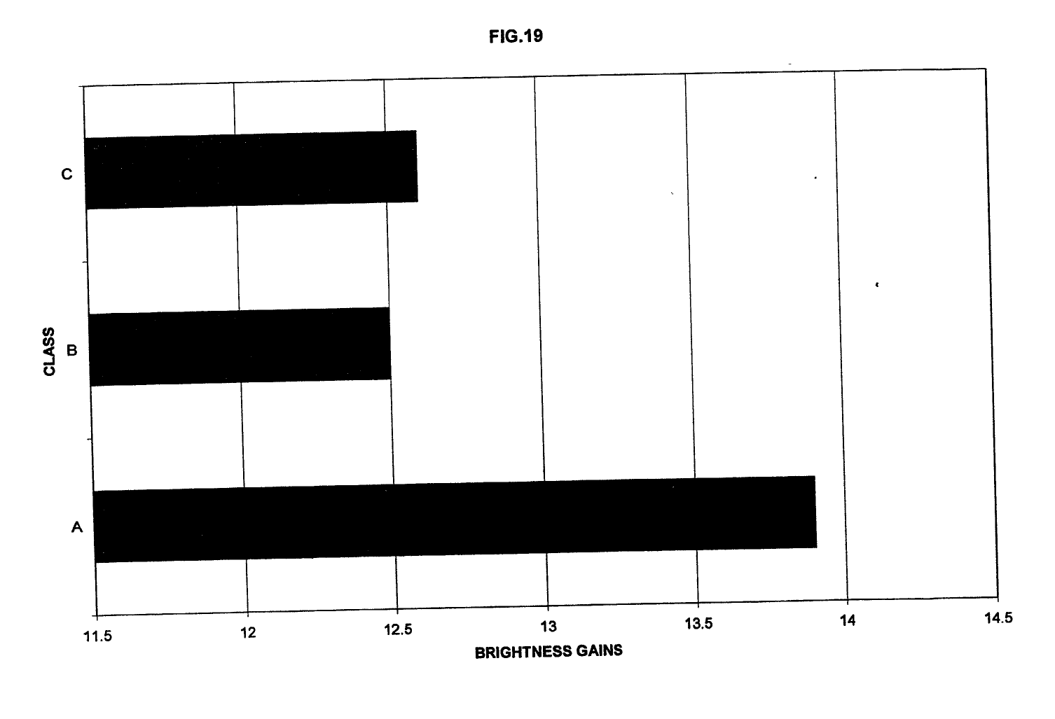

FIG. 19 shows the highest brightness gains for each class of clays as defined herein.

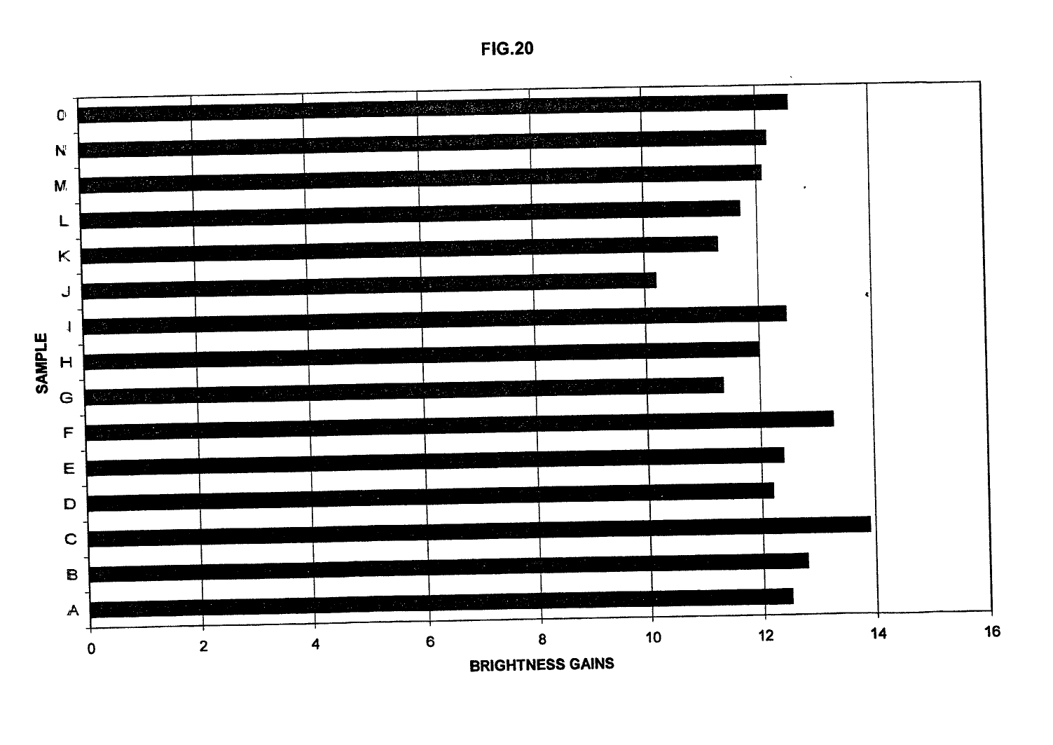

FIG. 20 shows the brightness gains obtained by magnetic separation under conditions defined in Example 14.

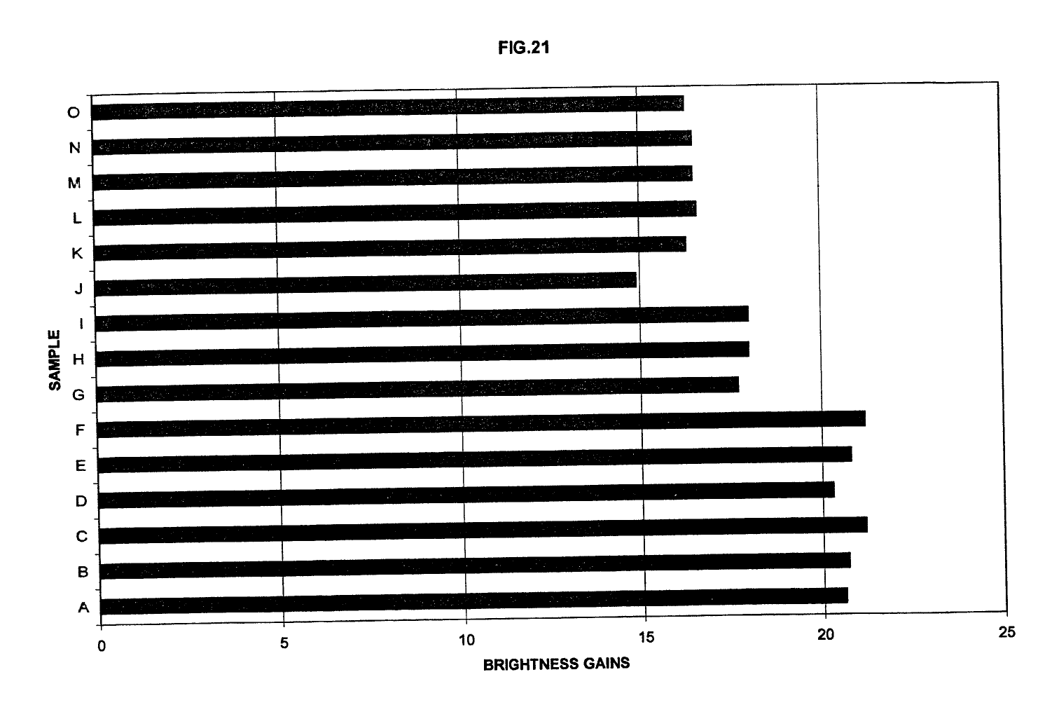

FIG. 21 shows the cumulative affect of magnetic separation and calcination or magnetic separation and leach for the various samples as defined in Example 14.

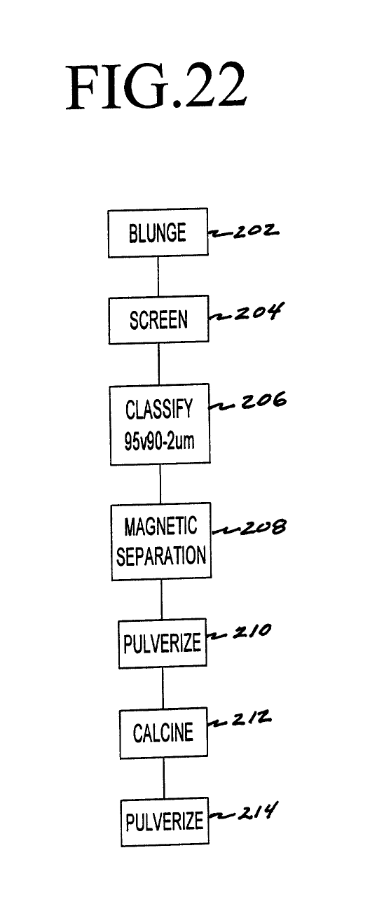

FIG. 22 is a flow sheet showing one of the processes of the present invention as set forth in Example 17.

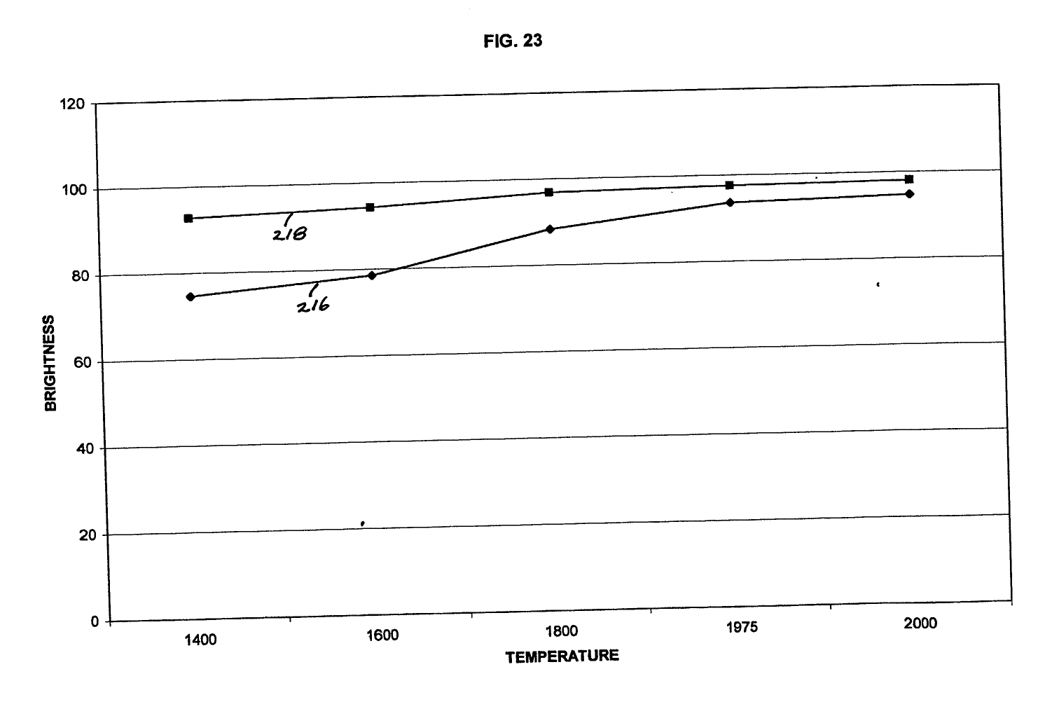

FIG. 23 shows brightness and L values as a function of calcination temperature.

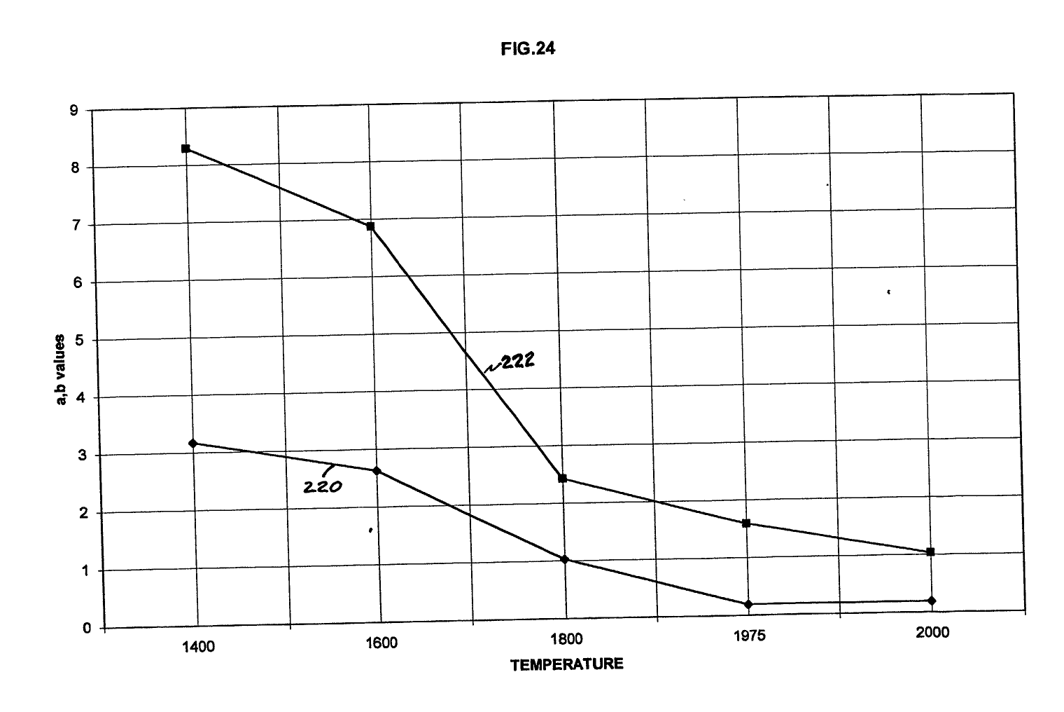

FIG. 24 shows a, b values as a function of calcination temperature.

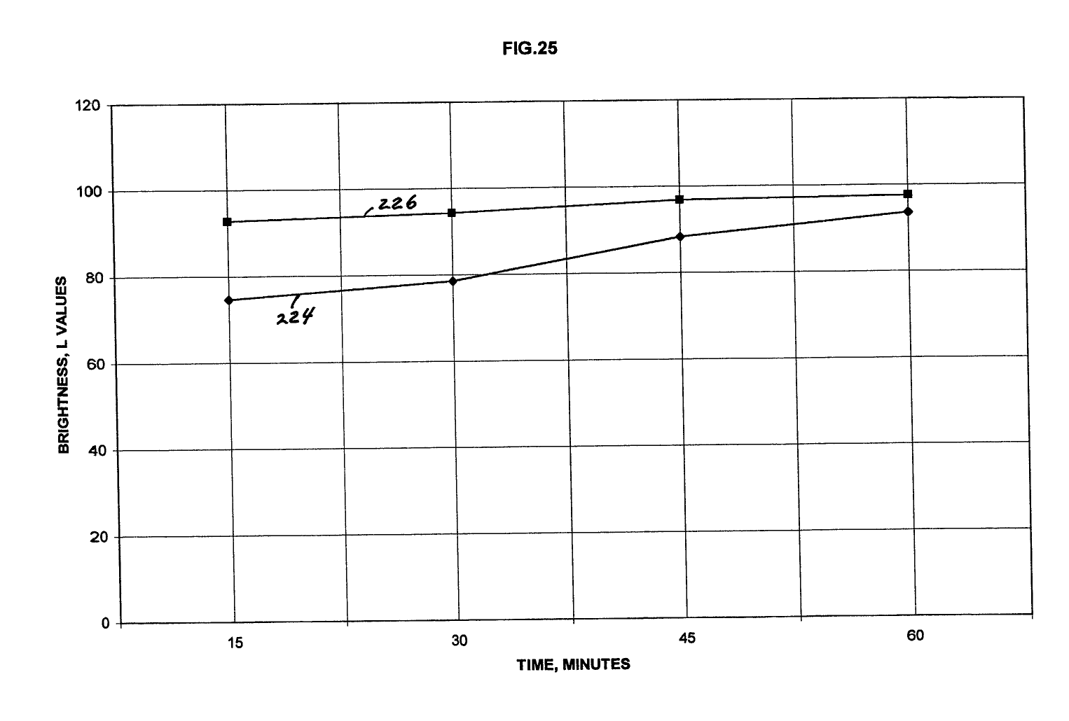

FIG. 25 shows brightness and L values at varying treatment times.

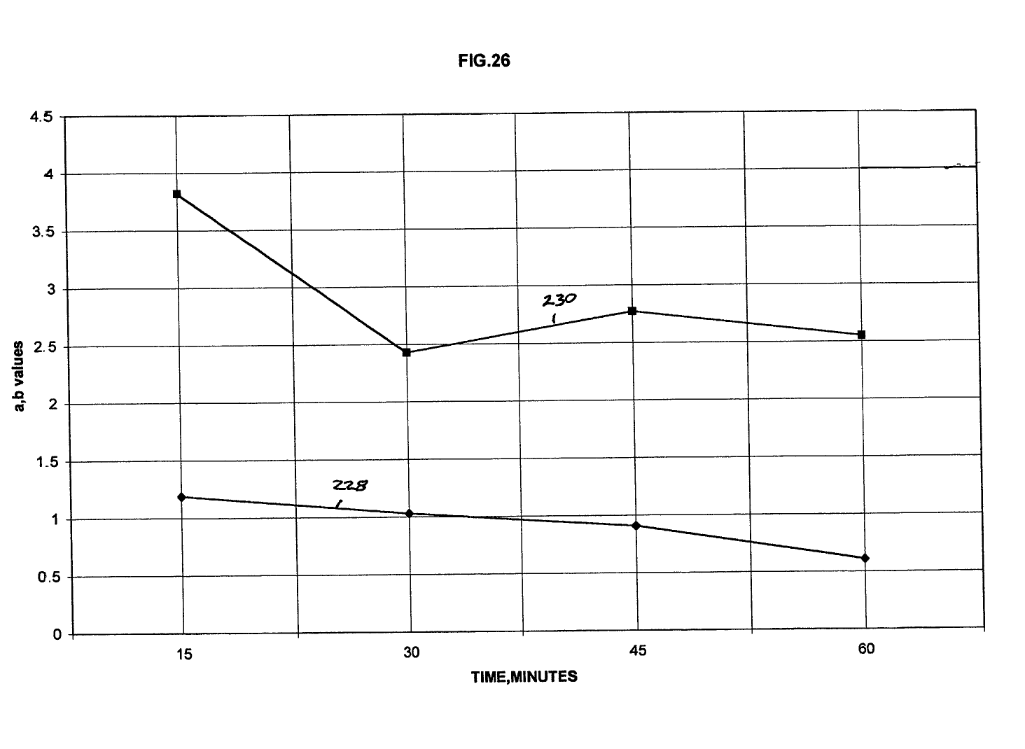

FIG. 26 shows a, b values at various treatment times.

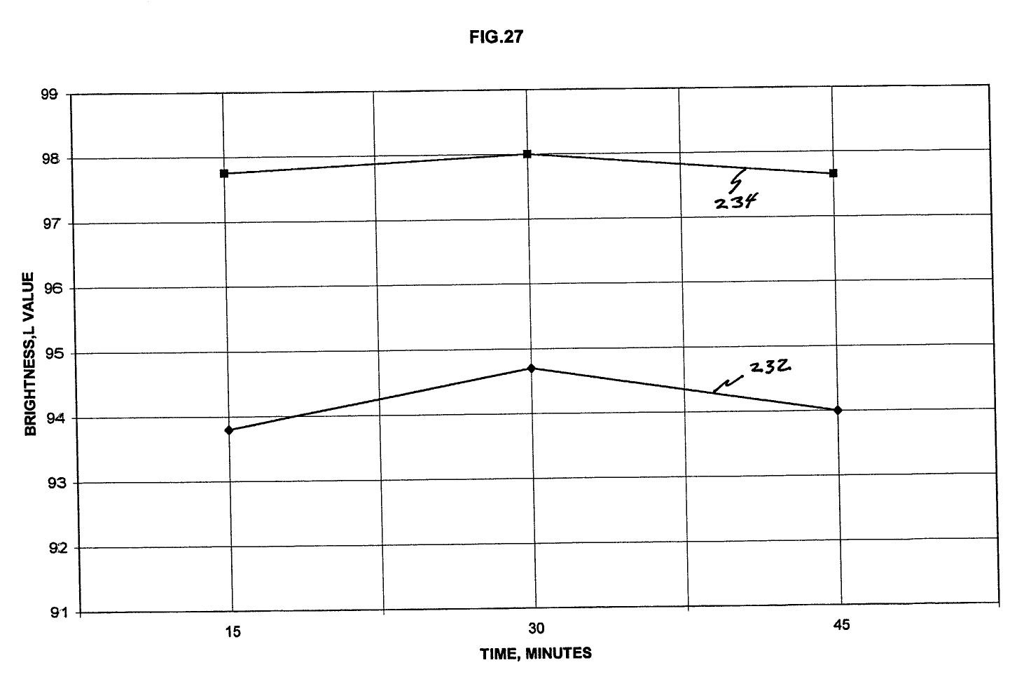

FIG. 27 shows the brightness and L values at various treatment times.

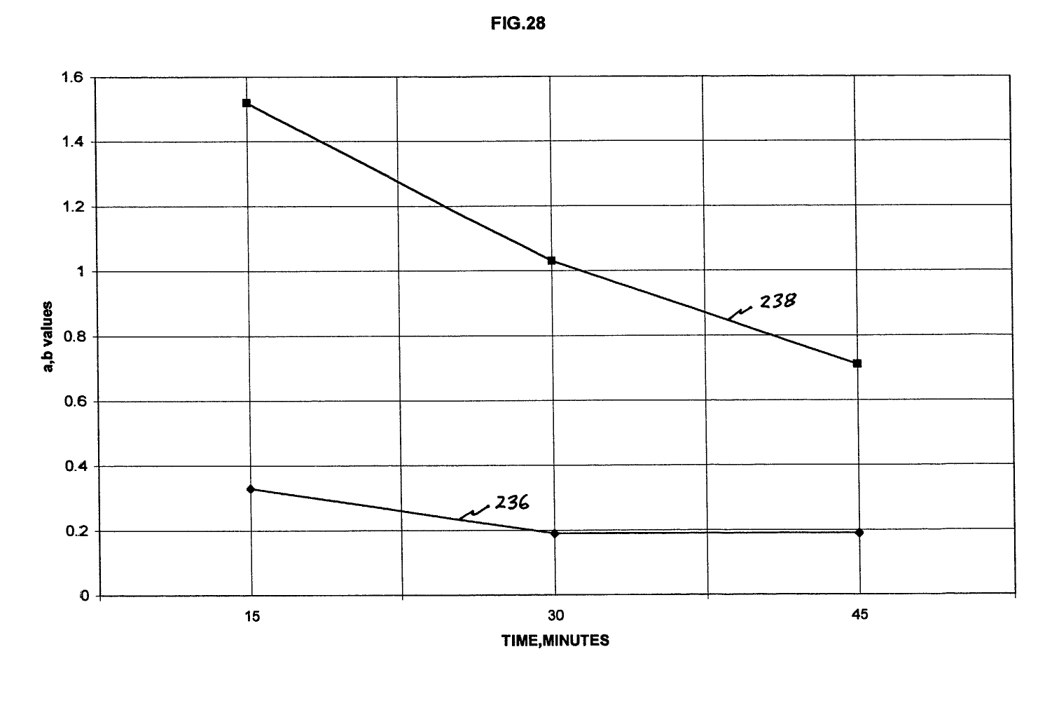

FIG. 28 shows the a, b values a various treatment times.

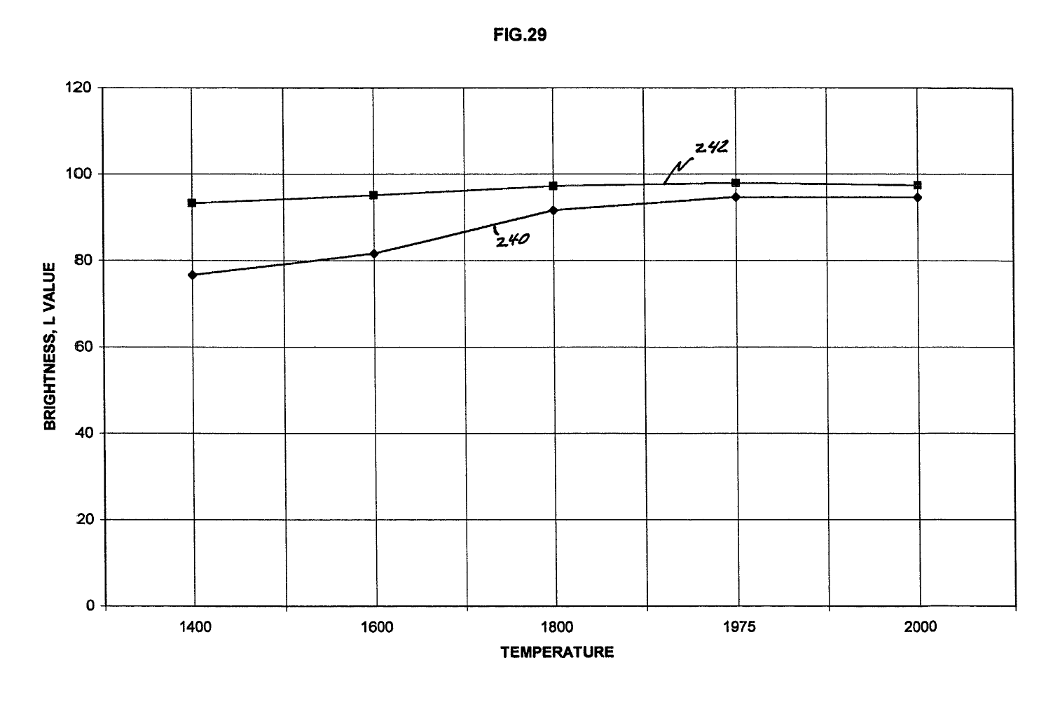

FIG. 29 shows the brightness and L values at various calcination temperatures.

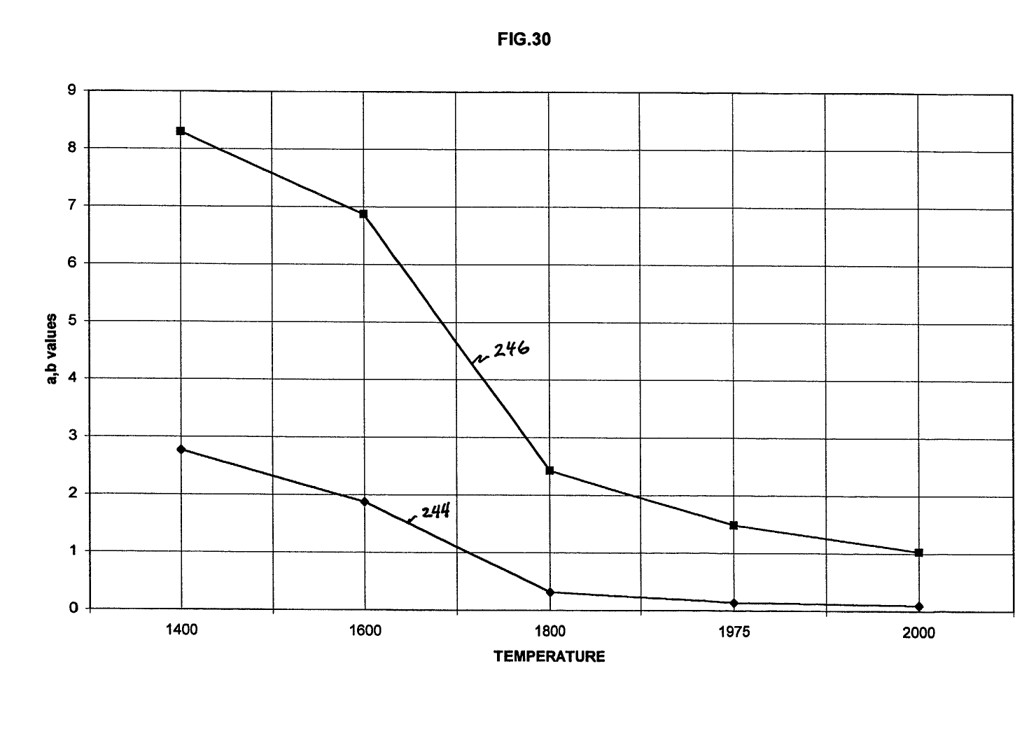

FIG. 30 shows the a, b values at various calcination temperatures.

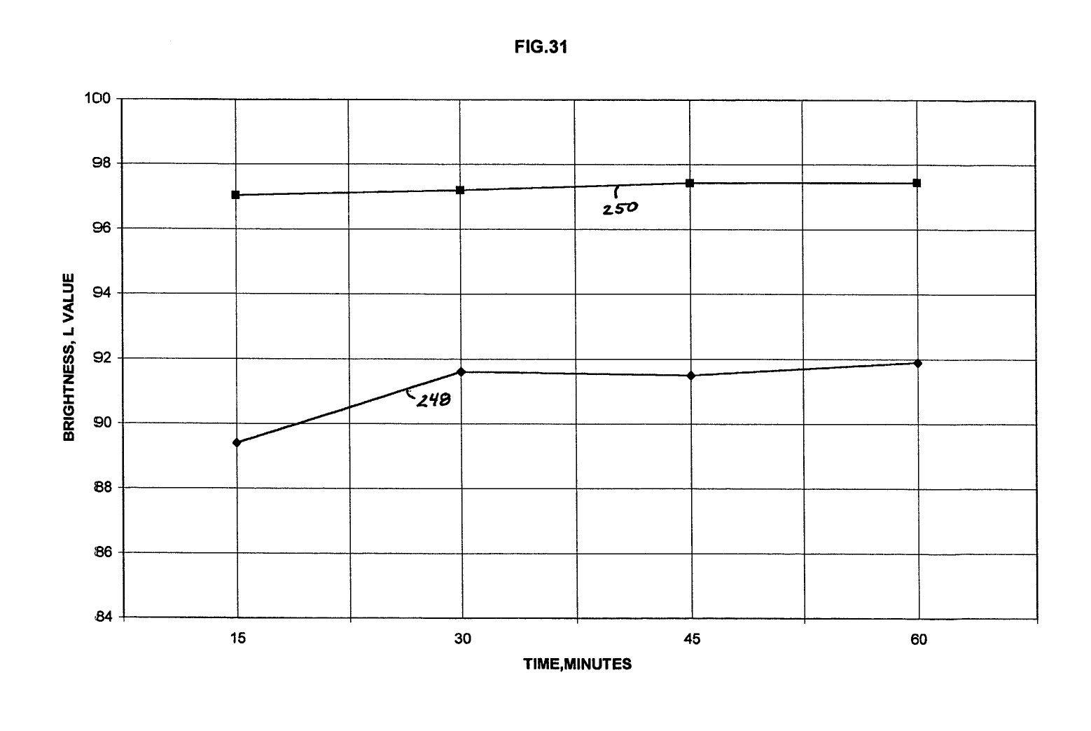

FIG. 31 shows the brightness and L values at various times.

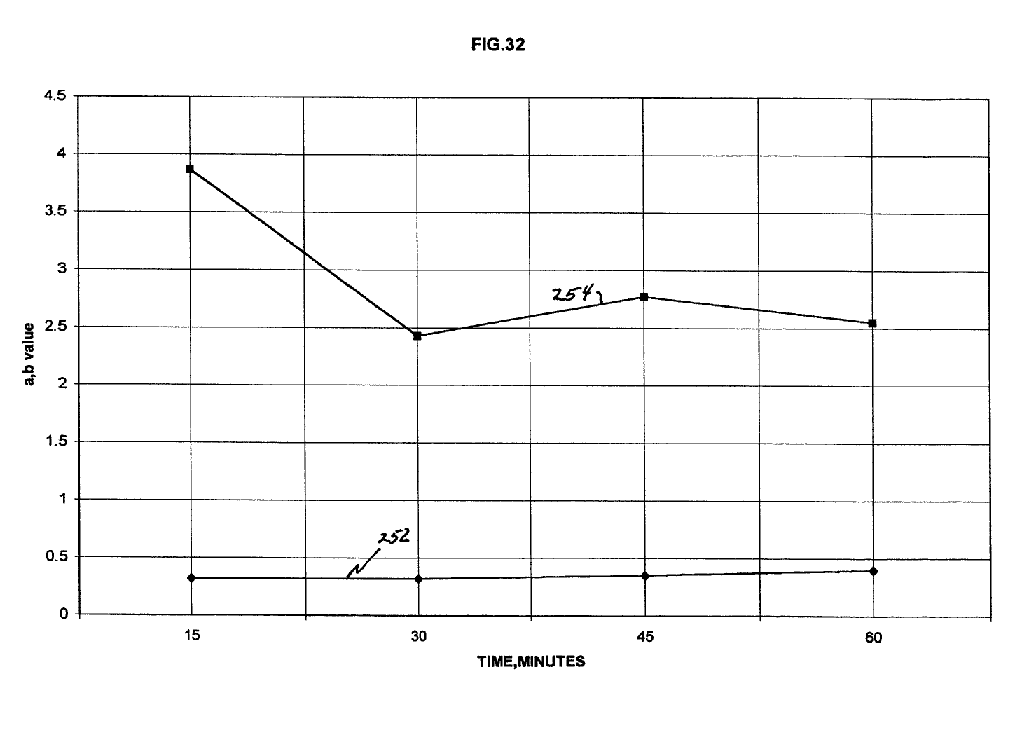

FIG. 32 shows the a, b values at various times.

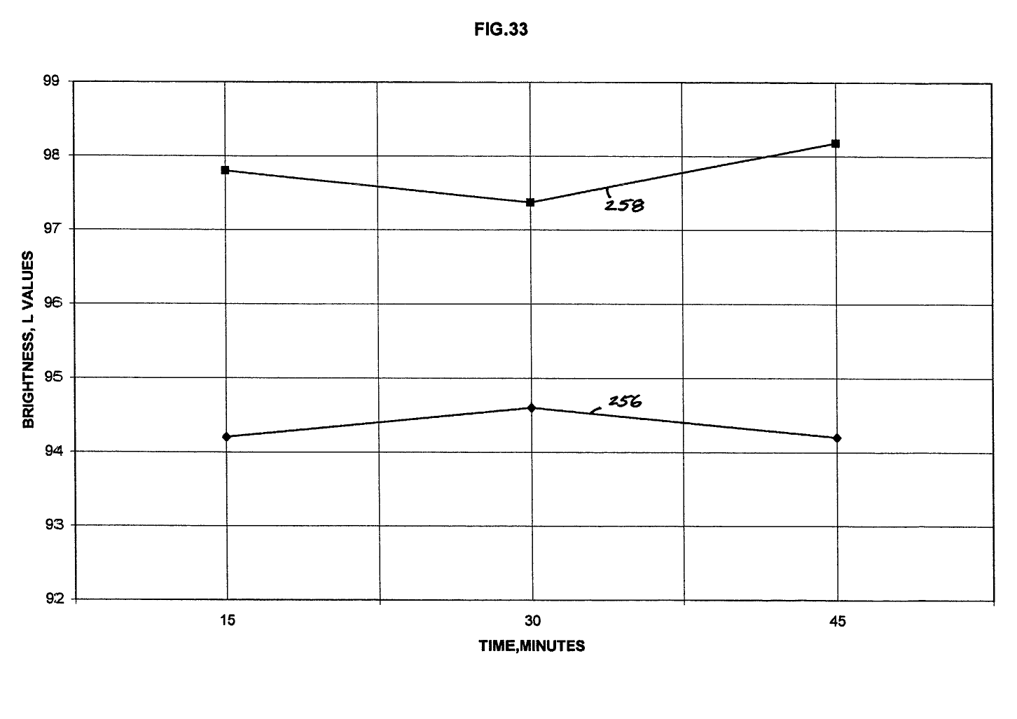

FIG. 33 shows the brightness and L values at the specified treatment times.

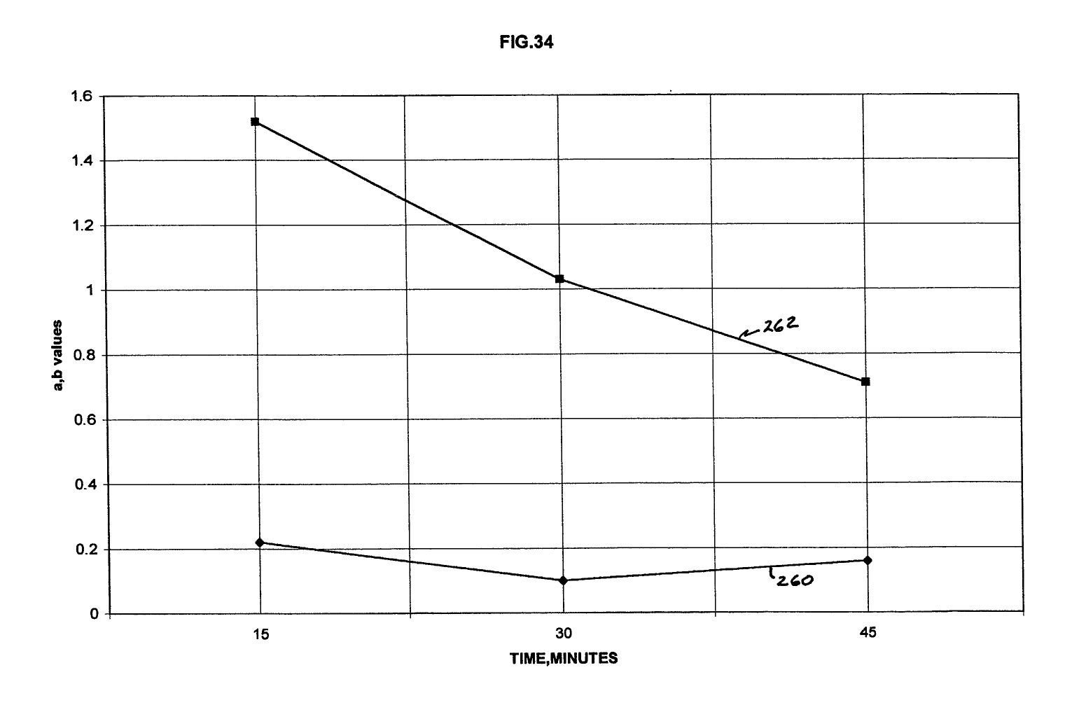

FIG. 34 shows the a, b values at the specified times.

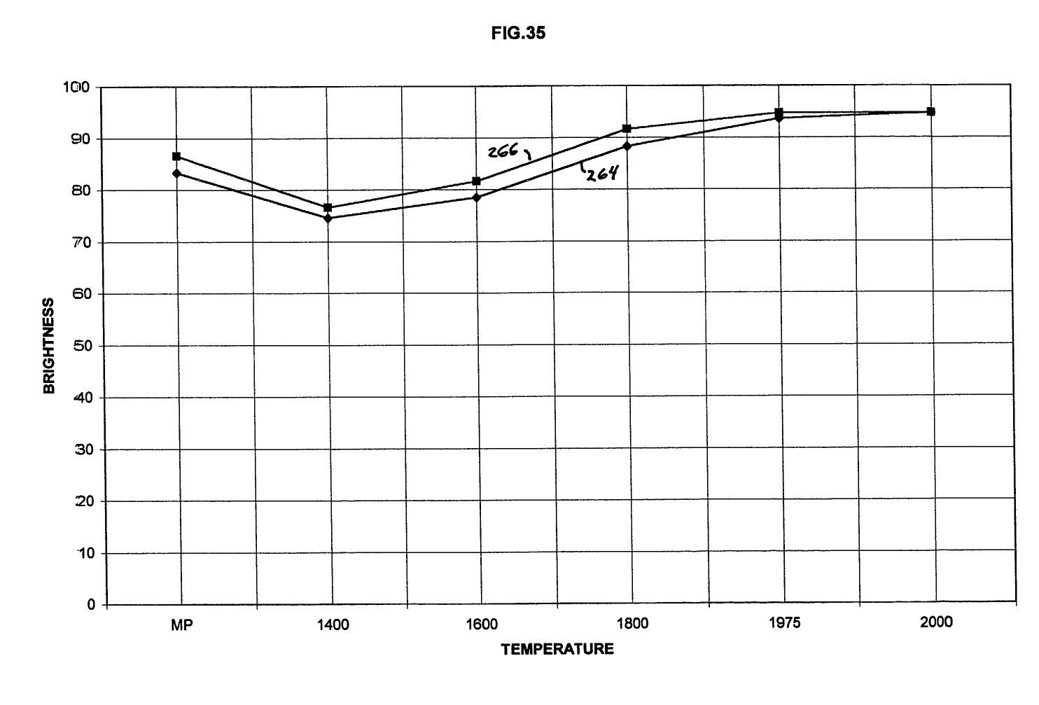

FIG. 35 shows the brightness-temperature profile of two clay fractions.

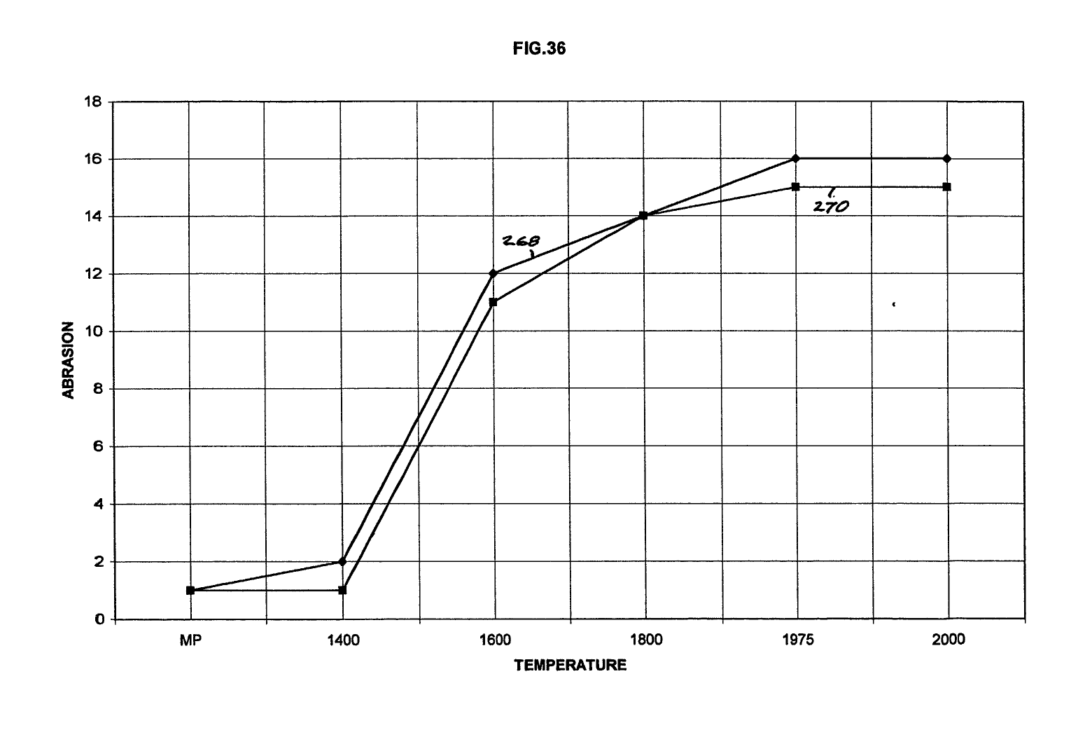

FIG. 36 shows an abrasion-temperature profile.

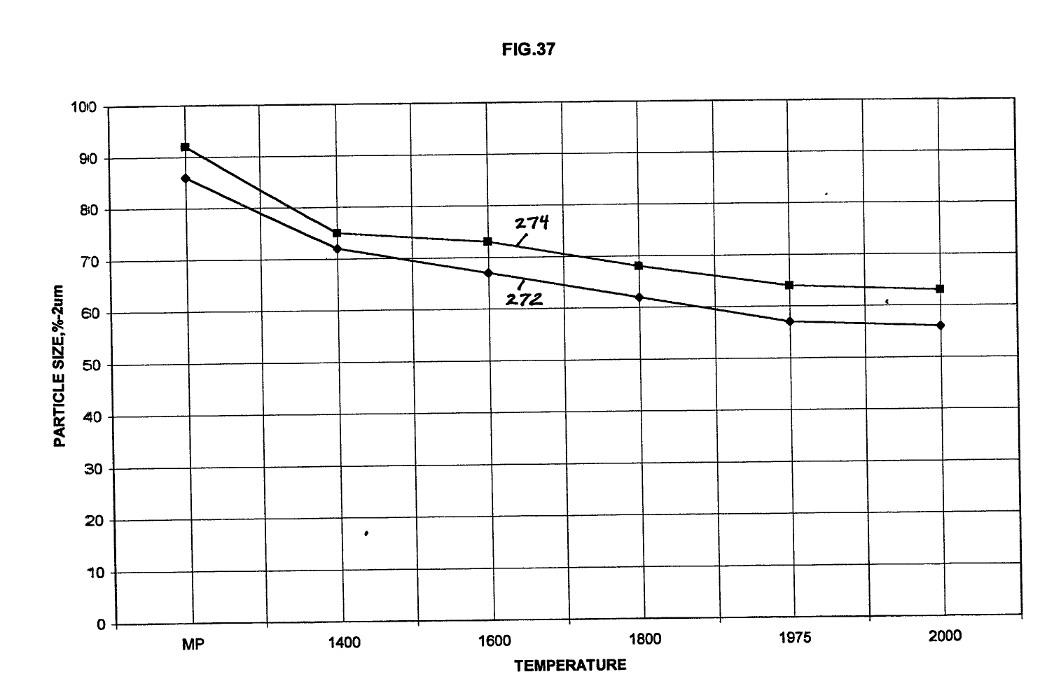

FIG. 37 shows a particle size-temperature profile.

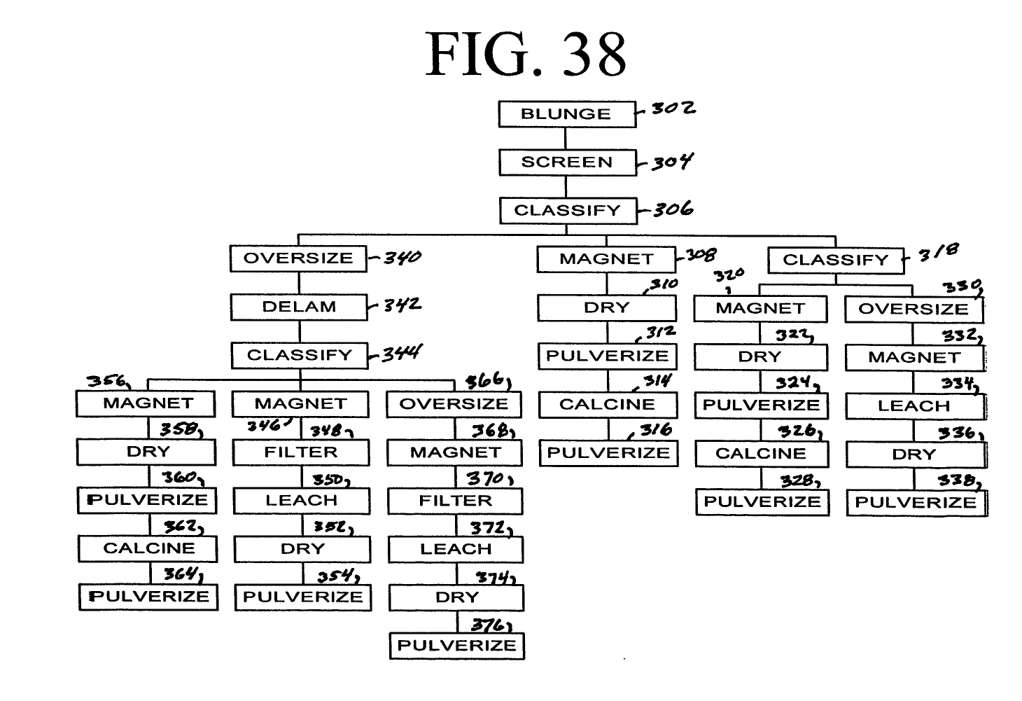

FIG. 38 is a flow chart of various alternative processes in accordance with the present invention.

In the accompanying drawings, like elements are given the same or analogous references when convenient or helpful for clarity. The same or analogous reference to these elements will be made in the body of the specification, but other names and terminology may also be employed to further explain the present invention.

### GENERAL DESCRIPTION OF THE INVENTION

For a further understanding of the nature, function, and objects of the present invention, reference should now be made to the following detailed description taken in conjunction with the accompanying drawings. Detailed descriptions of the preferred embodiments are provided herein, as well as, the best mode of carrying out and employing the present invention. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner. The practice of the present invention is illustrated by the following examples which are deemed illustrative of both the process taught by the present invention and of the product and article of manufacture yielded in accordance with the present invention.

It has been discovered that significant deposits of primary clay exist which have heretofore been put to only marginal, if any, use. It is believed that one of the reasons for the past lack of interest in these deposits is that there is no recognized method of finding and defining the extent of these deposits. It may also be that the deposits were not considered to be of significant commercial interest as they appeared to be heavily and darkly stained with yellow and red impurities.

It is no doubt true that there are many remaining deposits for which these conclusions may be applicable and appropriate. The present invention is directed to a class of clays that while superficially appearing to be too heavily and darkly stained to be of commercial interest, have been discovered and found to be clays capable and having the potential of yielding some of the brightest and whitest products ever produced.

In order to proceed with this line of thinking it is helpful, and even necessary, to define the unique raw material and the resultant primary crude kaolin characteristics to which the present invention is directed.

The Unique Raw Material-Resultant Primary Crude Kaolin Characteristics

These deposits are often highly discolored, off color red, red-yellow clay and ancillary minerals including kaolinite particles associated with discrete iron and titanium impurities. The kaolinite particles are in general of medium crystallinity and are of a coarse particle size with from 40 to 60% being less than 2 microns. At the same time the kaolinite particles are plate like and very thin—having a higher 15 aspect ratio and being more platy than currently available commercial products.

Factors Influencing Formation of High Quality Primary Kaolin

If the above describes the desired feed material, we must then turn to consider the factors influencing the formation of such high quality primary kaolins. Among the factors are the following:

1) Weathering Environment

2) Source Rock/Primary Clay

3) Cover

4) Post Saprolitization Weathering Environment and Geochemistry.

While the order of consideration is to some degree arbitrary, we will consider the above factors in turn in the order set forth above.

1) Weathering Environment

The formation of primary saprolite in the southeastern United States and to a great extent much of the world's commercial kaolin occurred during periods of global warming during the last 120 million years . As used herein the term “saprolite” refers to a disintegrated and somewhat decomposed rock that lies in its original place.

During the late Cretaceous to late Paleocene period, tropical climatic conditions prevailed from 40 degrees south latitude to 50 degrees north latitude. This period of high temperatures, high rainfall, and rapid drainage provided the necessary geochemical environment for the leaching of soluble compounds and for rapid chemical weathering of bedrock to occur.

The intensity of leaching is partially related to the volume of water passing through the soil and the saprolite, and therefore high porosity of both cover rocks and protoliths resulted in thicker and potentially higher quality crude kaolin.

2) Source Rock/Protolith

The saprolite is defined as the residual material resulting from intense chemical weathering of the source rock. The fact that the primary clays formed in-situ and therefore were not subjected to degradation relating to sedimentary transport is of primary importance in explaining the unique character of the primary crude clays versus sedimentary crude clays. Thus, understanding how to identify the ideal source rock to form the highest quality crude primary kaolin is an important aspect of the present invention.

A leucocratic (low iron and titania), medium to coarse grained, post-metamorphic, per-aluminous, biotite (+/−muscovite) granite is the preferred source rock for the development of high quality clay.

“Leucocratic” as this term is applied herein refers to light-colored rocks containing less than 30% dark minerals and having a color index of less than 30. This term implies and is used to indicate a low content of dark-colored mafic materials rich in magnesium and iron: biotite, hornblende, sphene, ilmenite, magnetite and the like, thus indicating low concentrations of iron, titania, magnesium and the like and therefore resulting in the formation of a saprolite with less impurities.

The term “peraluminous” as this term is applied herein refers to rocks in which the molecular proportion of alumina exceeds that of soda, potash, and lime combined.

The term “biotite” as used herein refers to a rock containing one or more forms of magnesium-iron mica and as indicated above which may or may not be associated with muscovite micas.

Granite/Igneous:

These rocks typically contain 40 to 60% sodium and/or potassium feldspars from which primary kaolin may be derived. Primary saprolites are by definition formed in-situ and therefore have not been influenced by the mechanisms of sedimentary transport, which may have introduced iron and organic material into the clay in ways which make it particularly difficult to remove them.

Such granites are found within the 325 to 265 million year old plutons in the central and eastern Piedmont of the southeastern Appalachians (Alleghanian Plutons). The area of interest is a 50 by 450 mile belt extending from Georgia to Virginia.

Post Metamorphic:

The majority of the saprolite source rocks along the Fall Line are metamorphosed rocks of igneous, volcanic and sedimentary origin. These source rocks typically produce saprolite of inferior quality relative to the post-metamorphic age rocks as they have been altered to produce a rock with increased silica, mica, quartz veining, sulfides, and finer grain size.

Grain Size:

A medium to course grain size is preferred as finer grains have greater exposure to impurities. That is to say they have proportionally more surface area exposed to contamination. While if the materials have a very coarse grain size (porphyritic to pegmatitic), some relic feldspar cores may remain or potassium may remain in solution which may result in unfavorable mineral species. The medium to course grained granite also provide a higher porosity host for groundwater flow.

Iron Impurities:

The iron impurities of the primary saprolites include stoichiometric and non-stoichiometric iron compounds and complexes and are predominately discreet, individual, colloidal particles including: hematite Fe₂O₃ (providing higher magnetic attraction and better response to acid leach); goethite HFeO₂; and limonite FeO (OH).nH₂O (alters to hematite easily through loss of water).

3) Cover:

In order for a saprolith to develop and be preserved, an overlying cover must be present to restrict physical weathering. In the southeastern United States, this cover is primarily known as the Atlantic Coastal Plain. The Atlantic Coastal Plain is composed of marine and submarine sediments (quartz sand, clay and limestone) which were deposited during fluctuations in sea level during the Cretaceous and Tertiary Periods. The Atlantic Coastal Plain sediment cover extends from southeastern Georgia northeast into North Carolina. Primary clay targets are found in a zone present along the northern edge of this feature. North of this zone the primary clays have been eroded and to the south they are either not well developed, are less mature, or are too deep to be of economic significance and interest.

4) Type of Cover:

In addition to the presence of cover being of critical importance, it is theorized that the type of cover and geographic location has the potential to promote greater depth of weathering and higher quality crude clay. A medium grained, high purity quartz sand with low clay content would provide a naturally purifying and porous channel for groundwater and surface waters penetrating the saprolite.

It is hypothesized that a gentle slope provides the hydraulic gradient necessary to maintain a moderate flow of water. It would also be important to have strongly oxygenated ground water. This environment presents itself in the form of wide, gently sloping riverbanks, which would have been present during the Cretaceous period, similar to the present day Amazon or Esequibo rivers. Tropical rivers tend to have relatively small bed loads and hence erosive power, so that chemical weathering is an important factor in valley development. These bank areas would have been influenced by higher flow rates of fresh river water and surface water more charged with oxygen and frequent periods of wetting and drying providing an environment of even more rapid leaching and removal of soluble compounds versus elsewhere along the Fall Line.

These areas of paleo-channels are believed to be represented today, on a regional scale, by areas of coastal plain cover extending north of the present day Fall Line, overlapping the crystalline rocks of the Piedmont. Although these paleo-channels provide one of the main target areas, broad, gently sloping areas with favorable coastal plain cover and underlying source rock, also provide viable targets for high quality primary kaolin.

5) Post Saprolitization Weathering Environment and Geochemistry:

As with sedimentary deposits, the high quality primary kaolin deposits may not have formed as commercial quality, but may have gone through cycles of further weathering, post-formation leaching, oxidation, and diagenesis, modifying and improving the quality of the deposit. Many of the factors identified above might have continued to be important through the present day as the central Georgia area is considered to be within a subtropical climate zone encouraging plant growth and rapid weathering through moderate to high temperatures and moderate rainfall. There is little doubt that high groundwater flow rates, variations in pH, periods of high rainfall, and erosion of the Atlantic Coastal Plain cover, have a continued impact on the quality of the kaolin of the primary clays.

### DETAILED DESCRIPTION OF PREFERRED EMBODIMENTS OF AND BEST MODE FOR CARRYING OUT THE PRESENT INVENTION

Utilizing the teachings above, the method of exploring for the primary crude kaolin of the present invention includes:

1) evaluating the geology along the Fall Line stretching diagonally across the middle of Georgia, protruding into South Carolina and extending into Virginia and for 50 miles north of said Fall Line for the preferred leucocratic, medium to coarse grained, post-metamorphic, peraluminous, biotite granite;

2) evaluating the weathering environment to which said granite has been subjected;

3) evaluating the type of cover within the Atlantic Coastal Plain cover of said granite; and

4) evaluating the post saproliitization weathering environment and geochemistry;

5) drilling test cores to define the location of the primary kaolin wherein the kaolin is of coarse particle size, the kaolinite of high whiteness and purity associated with discrete, removable iron and titanium impurities and having a particle size of 40-60% less than 2 microns and very thin, plate like kaolinite particles having a high aspect ratio.

6) subjecting at least selected core samples to magnetic separation to confirm the easy removability of said iron and titanium impurities;

7) extracting kaolin from selected deposits and beneficiating it by one or more of the following unit operations: blunging, screening, classifying, delaminating, magnetically separating, drying, pulverizing, filtering, leaching, or cacining to produce high brightness, filler, coating, delaminated, or calcined products.

The above described materials are so constituted as to have the suite of minerals found within the saprolite to be very discrete mineral assemblages. This fact allows for efficient and effective physical and chemical separation during the beneficiation process.

It is a further advantage of the present discovery and invention that the kaolinite particles are platy and contain aggregations and particle stacks susceptible of further processing. The kaolinite is coarse in particle size ranging from 40% to 60% <2 u. The non-processed brightness of the kaolin ranges from a low of approximately 55% GEB to approximately 85% GEB.

The materials which have been discovered by employing the above described method constitute a unique starting material for the production of a wide range of products. These starting materials, of course, contain impurities associated with the clays. The impurities are, in general, discrete and may be separated from the kaolinite under the proper processing conditions. The unique characteristics of these starting materials allow for very efficient and cost-effective separations even through the crude clay brightness values are very low as compared to existing commercial, secondary clay deposits.

The in-situ crude resources on a dry basis may contain approximately 43% kaolinite, 53% quartz and 4% mica.

A wide variety of products may be produced from these unique crudes, as will be discussed below.

With regard to the production of delaminated kaolin, two major process will be discussed below.

The first may be termed the “cog” method, where “cog” relates to the process steps of “classification oversize fraction grinding”. In this process the coarse oversize clay from a primary classification process is used as the feed clay.

The second method is that of the “whole clay grinding” (“wcg”) method which may include two or more grinding phases. In the first phase the whole crude is ground to change the % <2 um by, for example, 10%. In a second grinding phase the whole crude is ground to change the % <2 um by, for example, 25%.

The term “mechanical size reduction” is intended to include all means of achieving such ends including particularly sand and glass/plastic bead grinding. It is to be further understood that mechanical size reduction includes grinding, pulverizing and micro-pulverizing and may be employed at virtually every stage of the process of the present invention. Such processes may be employed on one side or the other of virtually each and every unit operation or if desired on both sides of such unit operations.

In general, the present invention demonstrates not only that exceptional high brightness products may be produced from the unique starting materials which are a part of the present invention, but also that unique thermally processed, calcined and delaminated products may also be produced in accordance with the present invention.

The blunging and degritting of the materials of the present invention may include two or more phases. The first may typically include material wet-out, low shear dispersion and coarse degritting and sand removal using equipment such as sand screws. The second phase may include medium-high shear dispersion and +325 mesh degritting and blunging.

The sand and clay separation may preferably be carried out using an inclined paddle mixer sometimes called a log washer at 20 to 25% solids in which the sand moves up the incline and is subsequently discharge at the top and the clay slurry overflows a weir at the lower end of the unit and is sent to the blunger.

In the blunger, the clay/water slurry is prepared by the controlled addition of a chemical deflocculant along with intensive mechanical agitation. The deflocculants most commonly used are sodium polyphosphate and sodium silicate. These reagents are often used in combination with sodium carbonate or sodium hydroxide as pH controllers. After measuring a dispersant demand, the entire sample is typically blunged at 60% solids using process water, dispersant and pH control modifiers added to maintain the pH between 7.0 and 7.5.

Typically, the blunged material is diluted to approximately 40% solids and degritted using a dragbox and/or screened using a 36 inch SWECO type screen equipped with a 325 mesh sieve.

Optionally, this process may include a “scalping” step in with 1% to 5% (typically 3%) of the larger clay particles and coarse impurities are removed at this stage prior to further processing.

Fractionation of the kaolin is typically accomplished with continuous, horizontal solid-bowl centrifuges with a helical conveyor screw. Feed slurry is introduced along the axis of the bowl and accelerates along the radius to bowl speed. Oversize particles are settled against the bowl wall and are conveyed to be discharges at one end. The fines remain in suspension and overflow a weir at the opposite end.

In the processes of the present invention, the various fully dispersed clay streams are subjected to high intensity, high gradient magnetic fields. Normally the slurry is passed through a canister equipped with a matrix of coarse, medium, fine or extra fine steel wool, (preferably stainless steel wool) depending on the properties of the suspension. As the slurry passes through the magnetic field, the contaminants attach to the steel wool and the purified clay suspension exits through the top of the canister.

The preferred system for the provision of the magnetic field is a superconducting magnet.

The iron oxide impurities associated with the clays of the present invention are very discrete which allows for their selective removal in an efficient and cost-effective manner even through the crude clay brightness values are very low as compared to existing commercial clay deposits.

Brightness gains greater than 10 GEB units have been consistently achieved with some samples responding as much as 20 GEB units to the magnetic separation process.

As noted above particle size reduction, grinding and pulverization may be applied before or after many steps in the process, if needed or desired. Grinding may be carried out in an attritor in which a single fixed-axis armature rotates several long radial arms. These mills are available in batch, continuous and circulation types. The grinding action is effected by the continuous, but irregular approach and retreat of the media in the vicinity of the arms. Typically sand or glass/plastic beads are used for this purpose.

Pre- and post-magnet “defining” in which approximately 10% of the dry weight of the ultra-fine/colloidal fraction is removed (typically by disk-nozzle centrifuges) may be used to advantage in accordance with the present invention.

Chemical leaching and filtration is typically carried out by heating the slurry with steam and introducing a leaching agent upstream of filters. Various mixing methods may be employed, preferably simple in-line mixers and loops of piping to allow for a reaction time on the order of 30 minutes. Once the clay has had sufficient time to react it is introduced into the slurry pan of a rotary vacuum filter which may typically be 10 to 15 feet in diameter and 36 feet long. These large drums rotate through the slurry pan with the vacuum applied and pick up a thin layer of clay which emerges from the slurry and is dried as it rotates. Rinse water may be applied part way around the vacuum cycle to wash away any residual salts. A coated roll picks the clay sheet from the filter with the aid of slight back pressure. The filtered clay is then reslurried and further processed. Optimum leach dosage has been found to be between 6 to 12 pounds per ton of clay. Maximum brightness gains after magnetic separation have been obtained using 6 pounds per ton to 12 pounds per ton of sodium hydrosulfite leach at a pH of 2 to 3.5. Brightness gains of 4 to 6 units were common and in some cases as much as 8 to 10 units of brightness were obtained.

It is even mare significant that these multi-unit brightness gains were in addition to the gains obtained with magnetic separation.

It is also to be noted that the best slurry rheologies and stabilities were obtained using the least amount of leaching and flocculation salts and their removal by washing and rinsing will significantly improve the rheology and stability of the kaolin slurry products.

The drying of the products of the present invention is most commonly accomplished by the use of spray dryers. In these operations the clay slurry is pumped to an atomizer which creates a fine mist which falls downward through a rising heated air stream. As the clay falls, it dries and is collected in the conical shaped bottom of the typical spray drier.

These methods and other features of the present invention will be illustrated in the following examples.

In all the following examples, unless stated to the contrary, the dispersant employed was sodium hexametaphosphate and the pH adjustments are made by sodium carbonate.

The leach employed was sodium hydrosulfite.

The dispersant employed in connection with obtaining the maximum dispersed state or minimum viscosity was Colloid C 211, sodium polyacrylate, or other suitable polyacrylate.

Hunter L, a, b values were measured using equipment and procedures described in U.S. Pat. No. 5,011,534, Young, col.8, line 45-66.

Ammonium polyacrylate, sodium polyacrylate, or other organic dispersants, as employed in conventional kaolin pigment processing, can be used in and as dispersants in the present invention.

### EXAMPLE 1

For use in the following examples of the classification oversize grinding method, the crude was processed as follows:

The crude clay was blunged at 42% solids and its pH adjusted to 7, with 6 pounds per ton of dispercant sodium carbonate. It was then screened through a 325 mesh screen recovering 45% with 50%-2 um and having a 73.2 brightness and an L value of 91.0, an a value of 1.29 and a b value of 8.05. This product was then classified to 90% <2 um with the fine fraction having a brightness of 74.1, an L value of 92.16, an a value of 1.27 and a b value of 9.46.

On magnetic separation at 3 Tesla and 0.5 cv per minute (canister volumes per minute) for 8 minutes through a fine fiber matrix a product was produced having a brightness of 86.3, an L value of 96.13, an a value of 0. 11 and a b value of 5.08.

The oversize fraction produced was 30% <2 um and had a brightness of 72.1 and an L value of 89.55, an a value of 2.02 and a b value of 6.87. These steps are shown in FIG. 2 in which the crude is blunged at 20, screened at 22 and classified at 24 to yield a fine fraction at 26 which is magnetically separated at 28 and an oversize fraction at 30.

### EXAMPLE 2

Starting with the above described oversize fraction from Example 1 and FIG. 2, the oversize fraction 30, as shown in FIG. 3, is subjected to magnetic separation at 25% solids and 3 Tesla with 0.5 cv per minute for 8 minutes through a fine fiber magnetic matrix to yield a brightness of 83.7 and a b value of 5.27. The magnetic product is further ground with glass beads to a 25 point delta at 2 um yielding a brightness of 85.3 and a b value of 6.41. This product is classified to 83% <2 um having a brightness of 85.9 and a b value of 4.17. Leaching with 9 pounds per ton of clay of leach yields a brightness of 89.1, an L value of 95.94, and an a value of −0.07 and a b value of 2.67.

When leached with 10 pounds per ton, the product yields a brightness of 90.0 and an L value of 95.98, an a value of 0.01 and a b value of 2.01. The 15 product had a Low Shear or Brookfield viscosity of 620 cps at 20 rpm and a High Shear or Hercules viscosity of 230 rpm at 18 dynes at 63.8% solids with 8 pounds per ton of dispersant.

The oversize fraction of the oversize product was 32% <2 um with a brightness of 84.8 and a b value of 4.17. With the application of 10 pounds per ton of leach, this oversize product yields a brightness of 88.2, an L value of 95.31, an a value of 0.12 and a b value of 2.48.

The above process is shown in FIG. 3 in which the oversize fraction 30 is subjected to a mechanical size reduction with a delta of 25 at 32, and magnetically separated at 34, and classified to 78-80% <2 um at 38, and leached at 42, with the oversize fraction 40 being separated at the classification 38, and leached at 44.

### EXAMPLE 3

Beginning with the oversize fraction 30, it is ground with glass beads to a 25 point delta at 2 um and classified to 78-80% <2 um yielding a brightness of 73.3 and a b value of 8.41. This product is then subjected to magnetic separation at 3 Tesla, 0.5 cv per minute for 8 minutes through a fine magnetic matrix to yield a brightness of 86.5 and a b value of 4.47.

With 9 pounds of leach per ton applied, a 92.0 brightness is obtained with an L value of 96.81, an a value of −0.08, and a b value of 1.77.

With the use of 12 pounds per ton of leach, a brightness of 92.2 is obtained with an L value of 96.84, an a value of −0.06, and a b value of 1.68. This product has a Brookfield viscosity of 710 cps at 20 rpm and a High Shear viscosity of 200 rpm at 18 dynes, 67.8% solids and 22 pounds per ton of dispersant.

The oversize of the oversize fraction is 41% <2 um and has a brightness of 74.4 and a b value of 6.14. On magnetic separation at 3 Tesla and 0.5 cv per minute through a fine fiber matrix yields a brightness of 85.4 and a b value of 4.46.

Application of 10 pounds per ton of leach yields a product of 90 brightness, having an L value of 96.04 and an a value of 0, and a b value of 2.18.

This process is shown in FIG. 4 beginning with oversize fraction 30 and mechanical size reduction 32. It is classified to 83% <2 um at 48.

This product is then magnetically separated at 50, and leached at 52. The oversize 50 of the classification 40 is also magnetically separated at 56 and leached at 58.

### EXAMPLE 4

Again, beginning with the oversize fraction 30, it is sand ground to a 25 point delta at 2 um and classified to 80% <2 um yielding a brightness of 72.2 and a b value of 8.34. This product is then subjected to magnetic separation of 3 Tesla at 0.5 cv per minute for 8 minutes through a fine fiber magnetic matrix to yield a brightness of 83.6 and a b value of 4.90.

With 9 pounds of leach per ton applied, the brightness was 89.5 with an L value of 95.8, an a value of −0.06 and a b value of 2.20. With the use of 10 pounds per ton of leach, a brightness of 90.2, with an L value of 95.9, an a value of 0.04 and a b value of 1.79 was obtained. This product has a Brookfield viscosity of 380 cps at 20 rpm and a High Shear viscosity of 220 rpm at 18 dynes and 65% solids with 8 pounds per ton of dispersant.

The oversize of the oversize fraction is 48% <2 um and has a brightness of 72.9 and a b value of 5.39. On magnetic separation in a 3 Tesla field and 0.5 cv per minute through a fine fiber magnetic matrix, the product yields a brightness of 84.2 and a b value of 4.76. Application of 10 pounds per ton of leach yields a product of 89.4 brightness with an L value of 95.61, an a value of 0.04 and a b value of 2.03.

This process is shown in FIG. 4 with the noted change in grinding media.

### EXAMPLE 5

The oversize fraction 30 is ground with carbolite to a 25 point delta at 2 um and classified to 83% <2 um yielding a brightness of 74.3 and a b value of 8.23. This product is then subjected to magnetic separation at 3 Tesla at 0.5 cv per minute for 8 minutes through a fine fiber magnetic matrix to yield a brightness of 87.6 and a b value of 4.21.

With 9 pounds of leach per ton applied, the product has a 92.1 brightness, an L value of 96.93, an a value of −0.09, and a b value of 1.86. With the use of 12 pounds per ton of leach, the product has a brightness of 91.1, an L value of 96.73, an a value of −0.01, and a b value of 2.31.

This product has a Brookfield viscosity of 770 cps at 20 rpm and a High Shear viscosity of 340 rpm at 18 dynes and 67.4% solids with 21 pounds per ton of dispersant.

The oversize of the oversize fraction is 40% <2 um and has a brightness of 72.7 and a b value of 6.31. On magnetic separation in a 3 Tesla field and at 0.5 cv per minute through a fine fiber magnetic matrix, the product has a brightness of 85.3 and a b value of 4.63. Application of 10 pounds per ton of leach yields a product of 89.9 brightness with an L value of 95.96, an a value of −0.01, and a b value of 2.13.

This process is shown in FIG. 4 with the noted changes in grinding media.

### EXAMPLE 6

The oversized fraction 30 is ground to 83% <2 um with glass beads to produce a 74.2 brightness and a b value of 6.88. It is magnetically separated in a 3 Tesla field with 0.5 cv per minute for 8 minutes through a fine fiber magnetic matrix to yield an 86 brightness and a value of 4.67.

With 9 pounds per ton of leach applied the product has a brightness of 89.0 with an L value of 96.29 and an a value of −0.28, and a b value of 3.20. With 12 pounds per ton of leach applied, the product brightness is 90.2, the L value is 96.49, the a value is −0.03, and the b value is 2.69.

The Brookfield viscosity of this product is 1850 cps at 20 rpm and the High Shear viscosity is 230 rpm at 18 dynes and 60.2% solids with 23 pounds per ton of dispersant.

The process of this example is shown in FIG. 5 in which the oversize fraction 30 is ground at 60 and magnetically separated at 62 and leached at 64, if desired.

### EXAMPLE 7

The following is an example of the whole clay grinding process (“wcg”). The crude clay is blunged with 6 pounds per ton of hexametaphosphate dispersant, and the pH adjusted with sodium carbonate to 7 at 40% solids. After screening through a 325 mesh, the material had 50% <2 um, a brightness of 73.2, an L value of 91.04, an a value of 1.29 and a b value of 8.05.

The material is then ground to a 10 point delta at 2 um with glass bead grinding yielding 60% <2 um, a 72.7 brightness and a b value of 8.16. This material is then classified to 90% <2 um as a fine fraction delaminated product having a brightness of 66.5 with a b value of 11.57.

The fine fraction is then subjected to magnetic separation in a 3 Tesla field at a flow rate of 0.5 cv per minute for 8 minutes through a fine fiber magnetic matrix to yield a brightness of 83.3 and a b value of 5.74. When leached with 10 pounds per ton, the product has a brightness of 90.5, an L value of 96.54, an a value of −0.05, and a b value of 2.44.

The oversize fraction from the above classification (to 90% <2 um) process has a brightness of 85.3 and a b value of 4.93 after magnetic separation. When leached with 10 pounds per ton of leach, it yields a 91.2 brightness, an L value of 96.54, an a value of 0.05, and a b value of 1.98.

The above process is shown in FIG. 6. The crude is blunged at 66 and screened at 68. It then undergoes a delta 10% reduction to a −2m at 70. The product is screened at 72 and classified to 90% <2 um at 74. This fraction is magnetically separated at 76 and leached at 78. The oversize fraction 80 from the 90% <2 um classification is magnetically separated to 82 and leached at 84.

### EXAMPLE 8

After blunging and screening as in Example 7, a portion of the delta 10 grind is classified to 83% <2 um. and has a brightness of 73.5 and a b value of 8.66. The fine fraction of this material when magnetically separated by subjection to a 3 Tesla field at a flow rate of 0.5 cv per minute for 8 minutes through a fine fiber magnetic matrix, yields a 84.6 brightness and a b value of 5.51. When leached with 9 pounds per ton, the product yields a 91.5 brightness, an L value of 96.78, an a value of −0.07 and a b value of 2.12. When subjected to leach at 12 pounds per ton, a brightness of 91.4 is achieved with an L value of 96.75, an a value of −0.07, and a b value of 2.10.

The product has a Brookfield viscosity of 370 cps at 20 rpm and a High Shear viscosity of 320 rpm at 18 dynes at 67.3% solids with 12 pounds per ton of dispersant. The oversize fraction of the 83% <2 um classification has 32% <2 um, a brightness of 73.4 and a b value of 6.59. Following magnetic separation under the same conditions as described above, the brightness was 83.1 and the b value 5.46. Following leaching at 12 pounds per ton, the brightness was 88.6, the L value 95.44, the a value 0, and the b value 2.34.

The above process is shown in FIG. 6. The crude is blunged at 66 and screened at 68. It then undergoes a delta 10% reduction at 2 um at 70. The product is classified to 83% <2 um at 74. This fraction is magnetically separated at 76 and leached at 78. The oversize fraction 80 from the 83% <2 um classification is magnetically separated at 82 and leached at 84.

### EXAMPLE 9

The crude clay is blunged with 6 pounds per ton of hexametaphosphate dispersant and the pH adjusted with sodium carbonate to 7 at 40% solids. After screening through a 325 mesh, the material had 50% <2 um particle size, a brightness of 73.2, an L value of 91.04, an a value of 1.29, and a b value of 8.05.

The material is then ground to a 25 point delta at 2 um with glass beads yielding 75% <2 um, a 71.8 brightness, and a b value of 8.51. This material is then screened through a 325 mesh screen and classified to 90% <2 um as a fine fraction delaminated product having a brightness of 71.2 with a b value of 8.86.

The fine fraction is then subjected to magnetic separation at 3 Tesla at a flow rate of 0.5 cv per minute for 8 minutes through a fine fiber magnetic matrix to yield a brightness of 83.4 and a b value of 5.93. When leached with 12 pounds per ton, the product has a brightness of 89.9, an L value of 96.43, an a value of −0.09, and a b value of 2.79.

The oversize fraction from the above classification (to 90% <2 um) process has a brightness of 84.9 and a b value of 5.21 after magnetic separation. When leached with 12 pounds per ton of leach, it yields a 91.4 brightness, an L value of 96.53, an a value of 0.05, and a b value of 1.84.

The above process is shown in FIG. 6.

### EXAMPLE 10

After blunging and screening as in Example 9, a portion of the delta 25 grind is classified to 78% <2 um and has a brightness of 72.7 and a b value of 2.56. The fine fraction of this material when magnetically separated by subjection to a 3 Tesla field at a flow rate of 0.5 cv per minute for 8 minutes through a fine fiber magnetic matrix, yields an 82.3 brightness and a b value of 6.32. When leached with 9 pounds per ton, the product yields an 89.6 brightness, an L value of 96.27, an a value of −0.24, and a b value of 2.78. When subjected to leach at 12 pounds per ton, the product has a brightness of 90.6 with an L value of 96.39, an a value of −0.04, and a b value of 2.17.

The product has a Low Shear or Brookfield viscosity of 470 cps at 20 rpm and a High Shear or Hercules viscosity of 260 at 18 dynes at 67% solids with 10 pounds per ton dispersant. The oversize fraction of the 83% <2 um classification has 45% <2 um, a brightness of 75.0 and a b value of 6.38. Following magnetic separation under the same conditions a described above, the brightness was 84 and the b value of 4.99. Following leaching at 10 pounds per ton, the brightness was 90.8, the L value 96.25, the a value 0.04, and the b value 1.92.

The process is shown in FIG. 6.

### EXAMPLE 11

Following procedures as set forth in the above examples additional examples were run to optimize the delamination process. A-E are coarse oversize grinding processes and F and G are whole crude grinding processes. Brightness figures are shown in FIG. 7.

Coarse Oversize Grinding:

A—sand grind, magnet, class 80% <2 um, leach, 65% solids for rheology.

B—glass bead grind, magnet, class 80% <2 um, leach, 67.8% solids for rheology.

C—carbolite grind, magnet, class 80% <2 um, leach, 67.4% solids for rheology.

D—magnet, glass bead grind, class 80% <2 um, leach, 63.8% solids for rheology.

E—glass bead grind to 80% <2 um, magnet leach, 60.2% solids for rheology.

Whole Crude Grind:

F—Delta 10, class 80% <2 um, magnet, leach, 67.3% solids for rheology.

G—Delta 25, class 80% <2 um, magnet, leach, 67.0% solids for rheology.

See FIG. 7 which shows the brightness of the magnetically treated 86 and leached 88 products, and FIG. 8 which shows the High Shear or Hercules viscosity 90 and the Brookfield viscosity 92.

In FIG. 8, the following are the % solids for the rheology:

TABLE I

A—65% solids
B—67.8% solids
C—67.4% solids
D—63.8% solids
E—60.2% solids
F—67.3% solids
G—67.0% solids.

The Low Shear or Brookfield viscosity is in cps at 20 rpm and the Hercules or High Shear viscosity is in rpm at 18 dynes. The numerical figures are plotted on a scale of relative rheology measurements and shown in FIG. 8.

With regard to the above examples it is to be noted that the products responded well to magnetic separation with additional brightness being gained during the leaching.

The plate like characteristics of the delaminated products, with high aspect ratios, create a dilatant slurry system at 67-68% solids.

In general the “cog” method produced the highest brightness products, 92+GE Brightness, using glass beads and carbolite as the grinding media, maintaining a grinding particle size delta of 25 and classifying up to 83% <2 um.

The “cog” method tends to produce a material balance of less fine clay and greater volumes of course clay products and fillers.

Products with the best low shear rheological properties were associated with the whole crude (“wcg”) process. These products were in the 300-500 cps range 67+% solids.

Both processes produced dilatant high shear products in the 200-300 rpm at 18 dynes range.

The whole crude method produces a material balance of less coarse clay feed and greater volumes of fine clay.

### EXAMPLE 12

Crude clay as described above having a TAPPI brightness of 69% and a particle size diameter of 50% <2 um was blunged, degritted on a 325 mesh and classified to 98% <2 um and then subjected to a 3 Tesla (30,000 gauss) magnetic field produced within an Advanced Cryo Magnetics, Inc. (ACMI) superconducting magnet having an 8 inch matrix depth and a cannister bore diameter of 4 inches. The magnet feed had a 74.3 brightness and was passed through a matrix of 22 um strand size packed to 7% density.

The process of the present invention as set forth in this example is shown in FIG. 9 in which the clay is blunged at 102, degritted at 104, and classified to 98% <2 um at 106, giving rise to an oversize 108. The 98% <2 um fraction is subjected to magnetic separation at 110, and calcined at 111.

Three flow rates were employed and brightness measurements taken at 2, 4, 6, 8, and 10 canister volumes (cv).

The flow rates employed may be expressed as cannister volumes (cv) and as the equivalent flow rate in cm/sec.:

1 cv=0.33 cm/sec.

0.5 cv=0.17 cm/sec.

0.25 cv=0.085 cm/sec.

A composite sample at each flow rate had the following brightness and calcined value:

1 cv—composite brightness 86.77—calcined brightness 94.92

0.5 cv—composite brightness 87.08—calcined brightness—95.02

0.25 cv—composite brightness 88.19—calcined brightness—95.50.

See FIG. 10 in which the TAPPI brightness has been plotted as a function of the number of magnetic cannister volumes per brightness check at the three different flow rates set forth above for the calcined clay magnet feed having a 99% <2 um under the conditions of the present example. Curve 112 is at a 1 cv flow rate. Curve 114 is at a 0.5 cv flow rate. Curve 116 is at a 0.25 cv flow rate.

### EXAMPLE 13

Using the crude and process of Example 12 in all respects except that the matrix had a strand size of 42 um packed to a 6% density. A composite sample at each flow rate had the following brightness and calcined values:

1 cv—composite brightness 86.53—calcined brightness 94.62

0.5 cv—composite brightness 86.68—calcined brightness 95.07

0.25 cv—composite brightness 87.56—calcined brightness 95.48.

See FIG. 11 in which the TAPPI brightness as a function of the number of cannister volumes per brightness check is shown at three different flow rates set forth above for the calcined clay magnet feed having 98% <2 um under the conditions of the present example. Curve 118 is at a 1 cv flow rate. Curve 120 is at a 0.5 cv flow rate. Curve 122 is at a 0.25 cv flow rate.

### EXAMPLE 14

The oversize fraction 108 from the process of FIG. 9 and Example 12 was delaminated and classified to 80% <2 um. (The oversize from this 80% <2 um classification was itself designated to be used as the filler which was 41% <2 um. The 80% <2 um delaminated clay had a 75.2 brightness and was passed through a 42 um strand size matrix packed to a 6% density at flow rates of 1 cv, 0.5 cv and 0.25 cv, and the brightness measured at 2 cv, 4 cv, 6 cv, 8 cv, and 10 cv.

As shown in FIG. 12, an oversize fraction 124 is delaminated at 126 and classified to 80% <2 um at 128. The 80% <2 um fraction is subjected to magnetic separation at 130 as described herein and leached at 132. The oversize fraction 134 from the classification at 128 is magnetically separated at 136 and leached at 138.

The resulting TAPPI brightness resulting from the number of magnet cannister volumes per brightness checks is shown in FIG. 13 for delaminated clay magnet feed of 80% <2 um in which curve 140 represents a flow rate of 1 cv and curve 142 represents 0.5 cv flow rate. The curve 144 represents 0.25 cv flow rate.

A composite sample had the brightness as shown initially and after leaching with 10 pounds per ton and 16 pounds per ton of clay as shown in FIG. 14. in which Curve 146 represents the results for a 1 cv flow rate . Curve 148 represents a flow rate of 0.5 cv. Curve 150 represents a flow rate of 0.25 cv.

FIG. 15 shows the TAPPI brightness as a function of the number of magnet cannister volumes per brightness check for a filler clay magnet feed (41%, 2 um) at 4% matrix packing density in which curve 152 is for a 1 cv flow rate. Curve 154 is for a 0.5 cv flow rate. Curve 156 is for a 0.25 cv flow rate.

FIG. 16 shows the TAPPI brightness as a function of the number of magnet cannister volumes per brightness check for a filler clay magnet feed (41% <2 um) at 6% matrix packing density in which curve 158 is for 1 cv flow rate. Curve 160 is for a 0.5 cv flow rate and curve 162 is for a 0.25 cv flow rate.

### EXAMPLE 15

The oversize from the 80% <2 um classification was designated for use as a filler having a 41% <2 um particle size and a 74 brightness. It was passed through a 75 um strand size matrix having a 4% density and through another matrix of the same strand size packed to a 6% density. Flow rates of 1 cv, 0.5 cv and 0.25 cv were used in each case with brightness measurements being taken after 2 cv, 4 cv, 6cv, 8 cv, and 10 cv. See FIG. 15 and FIG. 16 for the 4% and 6% density results, respectively.

Composite samples were formed for each flow rate having initial and leached brightness as shown in FIG. 17 for the 4% packing and in FIG. 18 for the 6% packing.

In FIG. 17, curve 164 is at a 1 cv flow rate. Curve 166 is at a 0.5 cv flow rate. Curve 168 is at a 0.25 cv flow rate.

In FIG. 18, curve 170 is at a 1 cv flow rate. Curve 172 is at a 0.5 cv flow rate. Curve 174 is at a 0.25 cv flow rate.

FIG. 19 shows the highest brightness gains through the magnet for each class of clays, namely 13.9 brightness points for calcined clay feed [A] using a 22 um strand size packed to 7% density with a flow rate of 0.25 cv; 12.5 brightness points for a delaminated clay feed [B] using a 42 um strand size packed to 6% density with a flow rate of 0.25 cv; and 12.6 brightness points for filler clay feed [C] using a 75 um strand size packed to 6% density with a flow rate of 0.25 cv.

### EXAMPLE 16

Calcined, delaminated and filler clay fractions were prepared as set forth in Example 14. Following magnetic separation, calcining of the calcined clay fraction, leaching of the delaminated and filler clay fractions, the TAPPI brightness gains were noted as shown in FIG. 20 and FIG. 21.

FIG. 20 shows the brightness gains obtained by magnetic separation alone and FIG. 21 shows the cumulative effect of magnetic separation and calcination in the formation of the calcined clay, while the brightness gains for the delaminated and filler clays reflect the cumulative effect of magnetic separation and leach.

The samples are the result of the application of the process conditions as set forth below:

A—calcined, 7% density, 22 um strands, 1 cv

B—calcined, 7% density, 22 um strands, 0.5 cv

C—calcined, 7% density, 22 um strands, 0.25 cv

D—calcined, 6% density, 42 um strands, 1 cv

E—calcined, 6% density, 42 um strands, 0.5 cv

F—calcined, 6% density, 42 um strands, 0.25 cv

G—delaminated, 6% density, 42 um strands, 1 cv

H—delaminated, 6% density, 42 um strands, 0.5 cv

I—delaminated, 6% density, 42 um strands, 0.25 cv

J—filler, 4% density, 75 um strands, 1 cv

K—filler, 4% density, 75 um strands, 0.5 cv

L—filler, 4% density, 75 um strands, 0.25 cv

M—filler, 6% density, 75 um strands, 1 cv

N—filler, 6% density, 75 um strands, 0.5 cv

O—filler, 6% density, 75 um strands, 0.25 cv.

In connection with the above examples, it is to be noted that a drop in brightness on each successful cannister volume processed and passed through the magnet is caused by the matrix being saturated with magnetically susceptible contaminants, thus reducing the probability of capture. This factor is compensated for in commercial production by providing for frequent flushing as needed and desired for the grade of clay desired to be produced.

Note the rapid change in slope of the brightness during the latter part of the cycle.

Brightness gains in excess of 10 units were achieved on all products under all experimental conditions.

Optimum conditions provide brightness gains greater than 12 G E brightness units.

The calcined clay final calcined product brightness improved over 20 GE brightness units.

The flow rates through the magnet have a significant impact with the slowest rates achieving a 1.4 brightness improvement of the faster rates.

The delaminated clay magnet feed improved over 17 GE brightness units.

Flow rates again have a significant impact with the slowest rates achieving a 1.15 brightness improvement over the faster rates. The final delaminated product brightness indicates that the leaching process can eliminate the flow rate variations.

The filler clay magnet feed improved over 10 GE brightness units under all conditions and improved over 12 GE brightness units when the matrix packing was 6%.

The filler clay final leached product brightness improved over 16 GE brightness units.

The final filler product brightness indicates that leaching may eliminate any variations resulting from flow rate variations when a 6% packing density is used.

### EXAMPLE 17

Clays of the present invention as shown in FIG. 22 were blunged at 202 at 60% solids and adjusted to a pH of 7. They were dispersed with 6 pounds per ton of hexametaphosphate and screened at 204 through a 325 mesh screen. They were then classified at 206 into two fractions-one 90% <2 um and the other 95% <2 um. Each fraction was then magnetically separated at 208 by flow through a 3 Tesla field with a 42 um strand matrix at a flow rate of 0.5 cv per minute. The purified fraction was then pulverized at 210 by two passes through a micropulverizer and various fractions were calcined at 212 at temperatures selected from the set of 1400, 1600, 1800, 1975 and 2000 Degrees F. for a time selected from the set of times 15, 30, 45, and 60 minutes.

The resulting products were again pulverized at 214 by two passes through a micropulverizer and the resulting products tested.

The calcine feed for the 90% <2 um fraction had a brightness of 83.25, an L value of 94.96, an a value of 0.52, and a b value of 5.56.

These values after calcination at various times and temperatures are shown in FIG. 23, FIG. 24, FIG. 25, FIG. 26, FIG. 27, FIG. 28.

FIG. 23 shows brightness curve 216 and L value curve 218 as a function of calcination temperature with 30 minutes treatment times.

FIG. 24 shows a,b values as a function of calcination temperatures with 30 minutes treatment times. Curve 220 represents a values. Curve 222 represents b values.

FIG. 25 shows brightness, curve 224, and L values, curve 226, at varying treatment times at a calcination temperature of 1800 Degrees F.

FIG. 26 shows a,b values at various treatment times at a calcination temperature of 1800 Degrees F. Curve 228 represents the a values and curve 230, represents the b values.

FIG. 27 shows the brightness values in curve 232 and the L values in curve 234 at the times shown at a calcination temperature of 2000 Degrees F.

FIG. 28 shows a and b values at the specified treatment times at a calcination temperature of 2000 Degrees F. Curve 236 reflects the a values. Curve 238 reflects the b values.

The calcine feed for the 95% <2 um fraction had a brightness of 86.6, an L value of 96.18, an a value of 0.65 and a b value of 4.77. These values after calcination at various times and temperature are shown in FIG. 29, FIG. 30, FIG. 31, FIG. 32, FIG. 33, and FIG. 34.

FIG. 29 shows the brightness and L values at the specified calcination temperatures at 30 minutes treatment time. Curve 240 shows the brightness. Curve 242 shows the L values.

FIG. 30 shows the a,b values at various calcination temperatures at a 30 minute treatment time. Curve 244 shows the a values. Curve 246 shows the b values.

FIG. 31 shows the brightness and L values at various treatment times at 1800 Degrees F. Curve 248 reflects the brightness and curve 250 the L values.

FIG. 32 shows the a,b values at the times specified at 1800 Degrees F. Curve 252 shows the a values. Curve 254 shows the b values.

FIG. 33 shows the brightness and L values at the specified treatment times at 2000 Degrees F. Curve 256 reflects the brightness and curve 258 the L values.

FIG. 34 shows the a,b values at the specified times at 2000 Degrees F. Curve 260 shows the a values and curve 262 shows the b values.

FIG. 35 shows the brightness-temperature profile of two clay fractions. Curve 264 reflects a 90% <2 um feed and curve 266 reflects a 95% <2 um feed fraction, both with 30 minute calcination.

FIG. 36 shows an abrasion-temperature profile with calcination for 30 minutes of a 90% <2 um fraction shown in curve 268 and a 95% <2 um fraction, shown in curve 270. The values would, of course. be approximately ½ of the reported values shown, if reported at 43,000 rpm.

FIG. 37 shows a particle size-temperature profile at 30 minutes calcination time. Curve 272 represents a 90% <2 um fraction and curve 274 represents a 95% <2 um fraction. The drop in % <2 um would, of course, be approximately one-half the reported values shown with commercial scale pre-milling and post-milling.

A maximum brightness of 94.7 was achieved at 2000 Degrees F. for 30 minutes for the 90% <2 um fraction and at 1975 Degrees F. for 30 minutes for the 95% <2 um fraction.

Processing times in excess of 30-35 minutes did not appear to contribute to product quality or processing efficiencies.

FIG. 38 is a flow chart of various alternative processes in accordance with the present invention. For example, beginning with the crude clay in accordance with the present invention, the crude clay is blunged at 302 and screened at 304 and then classified to 90% <2 um at 306. This 90% <2 um fraction may then be subjected to magnetic separation at 308, dried at 310, pulverized at 312, calcined at 314 and repulverized at 316 to produce, for example, a paint grade calcined clay.

The 90% <2 um fraction may be further classified at 318 to, for example, a 93% <1 um fraction which may then be subjected to magnetic separation at 320, dried at 322, pulverized at 324, calcined at 326, and repulverized at 328 to yield, for example, a paper grade calcined clay.

The oversize, 330, from the 93% <1 um classification at 318 may be subjected to magnetic separation at 332, leached at 334, dried at 336 and pulverized at 338 to produce a course filler product.

The oversize fraction 340 from the classification 306 may be delaminated at 342 and classified to, for example, 78% <2 um at 344. The 78% <2 um fraction may be subjected to magnetic separation at 346, filtered at 348, leached at 350, dried at 352 and pulverized at 354 to produce a delaminated product.

Alternatively, or by way of a divided fraction of the 78% <2 um classification at 344, such a fraction may be subjected to magnetic separation at 356, dried at 358, pulverized at 360, calcined at 362, and repulverized at 364 to yield, for example, a paint grade delaminated calcined product.

The oversize 366 from the 78% <2 um classification at 344 may be subjected to magnetic separation at 368, filtered at 370, leached at 372, dried at 374 and pulverized at 376 to yield a delaminated filler product.

The optimized combination of calcination and magnetic separation steps in various combination with other processing steps provides a high brightness calcined clay using only magnetic separation and leach as primary beneficiation steps.

While the parameters associated with various end uses are generally well known, because of the unique crude and feed materials which are the subject of the present discovery and invention, additional tests were performed to confirm and develop suitable alternatives as necessary for the utility and functionality of the products produced.

### EXAMPLE 18

The products of the present invention when compared to well known coarse UK filler (FillerM) in paper evaluations showed a 2 to 4 units higher sheet brightness and an improved yellowness, b value, both while maintaining comparable sheet opacity.

### EXAMPLE 19

In a delaminated clay study, coatings were produced having 0.2 to 1 units higher brightness than a standard Georgia delaminated clay (Nuclay). Lower yellowness (b values) were obtained as well as higher gloss values which were, also, obtained while achieving higher opacity.

### EXAMPLE 20

In a calcined study which compared the products of the present invention with Ansilex 93, an industry standard calcined clay, the clays of the present invention gave 0.5 to 1 unit higher brightness with greater opacity and higher sheet gloss.

### EXAMPLE 21

In paint studies, the clays of the present invention, when compared with Satintone W in a latex flat wall paint, showed higher brightness, superior reflectance and greater hiding power and opacity—in some cases up to 30% greater hiding power.

In each of these products, it should be noted that the Hunter a values and low b values reflect a higher response to magnetic separation which is unique in a feed material and which makes possible many diverse products. The naturally developed viscosity of the feed material also reflects the unique nature of the materials.

In addition to the above described processes and products it is to be understood that other advanced processing may be used in connection with magnetic separation and leaching to yield further brightness improvements, such as flotation, selective separation, selective flocculation and ozonization.

The thermal processing and/or calcination of the saprolite of the present invention adds significant brightness as well as structures the the kaolin particles for high light scattering coefficients. Calcined brightness gains of the magnet beneficiated feed ranged from highs on the order of 98 GEB to lows of 92 GEB. The abrasion values ranged from 12 to 20 (Einlehiner @ 87,000 rev). Maximum brightness values were achieved at 1975 to 2050 Degrees F.

The saprolites of the present invention are naturally platy and yield high quality delaminated clay products with delta grinds of 20 to 40 psd units.

A 3% scalping of the very coarse −325 mesh material improves product brightness.

Filler clay products may be produced from the saprolites of the present invention. These products are coarse, platy and of high brightness as compared to existing commercially available products with GEB on the order of from 85% to 91% GEB.

Different types of calciners may be used in connection with the present invention including vertical, rotary, flash and fluid bed calciners.

Due to the spherical shape of the spray dryer product, a pre-mill may be used to condition the dry clay prior to calcination or other heat treatment. Typically a hammer mill and air classifier combination may be used. Similarly such devices may be used to post-mill the calcined product to provide for lower abrasion while maintaining the required opacity characteristics and benefits.

### SUMMARY

The present invention utilizes a method of exploring for primary crude kaolin which includes evaluating the geology along the northern contact of the Atlantic Coastal Pain, a feature stretching diagonally across the middle of Georgia, protruding into South Carolina and for an indication of preferred source rock; evaluating the weathering environment to which said granite has been subjected; evaluating the type of cover within the Atlantic Coastal Plain cover of said granite; and evaluating the post saprolitization weathering environment and geochemistry; drilling test cores to define the location of the primary kaolin wherein the kaolin is of course particle size, the kaolinite of high whiteness and purity associated with discrete and removable iron and titanium impurities and has a particle size of 40-60% less than 2 microns and very thin, plate like kaolinite particles having a high aspect ratio; subjecting at least selected core samples to magnetic separation to confirm the easy removability of said iron and titanium impurities; and extracting kaolin from selected deposits and beneficiating it by one or more of the following unit operations: blunging, screening, classifying, delamininating, magnetically separating, drying, pulverizing, filtering, leaching, or calcining and other industrial mineral processing techniques to produce high brightness, filler, coating, delaminated, or calcined products.

It is to be noted that the unique starting materials of the present invention give rise to unique processes and products as set forth above. The unexpected degree of responsiveness of the materials to magnetic separation and the even further high degree of responsiveness to chemical leaching following magnetic separation are among the many unique and unexpected aspects of the present invention.

It is noted that the embodiment described herein in detail for exemplary purposes is, of course, subject to many different variations in structure, design, application and methodology. Because many varying and different embodiments may be made within the scope of the inventive concepts herein taught, and because many modifications may be made in the embodiment herein detailed in accordance with the descriptive requirements of the law, it is to be understood that the details herein are to be interpreted as illustrative and not in a limiting sense. It will be understood in view of the present disclosure, that numerous variations on the invention are now enabled to those skilled in the art. Many of the variations reside within the scope of the present teachings. It is not intended to limit the scope of the invention to the particular forms set forth, but on the contrary it is intended to cover such alternatives, modifications, and equivalents as may be included within the spirit and scope of the teachings of the present invention. Accordingly, the invention is to be broadly construed and is to be limited only by the spirit and scope of the claims appended hereto.

What is claimed is:

1. The method of exploring for primary crude kaolin comprising:
1) evaluating the geology along the northern contact of the Atlantic Coastal Plain, a feature stretching diagonally across the middle of Georgia, protruding into South Carolina and for an indication of preferred source rock;
2) evaluating the weathering environment to which said granite has been subjected;
3) evaluating the type of cover within the Atlantic Coastal Plain cover of said granite; and
4) evaluating the post saprolitization weathering environment and geochemistry;
5) drilling test cores to define the location of the primary kaolin wherein the kaolin is of medium crystallinity, course particle size, the kaolinite of high whiteness and purity associated with discrete and removable iron and titanium impurities and has a particle size of 40-60% less than 2 microns and very thin, plate like kaolinite particles having a high aspect ratio;
6) subjecting at least selected core samples to magnetic separation to confirm the easy removability of said iron and titanium impurities;
7) extracting kaolin from selected deposits and beneficiating it by one or more of the following unit operations: blunging, screening, classifying, delamininating, magnetically separating, drying, pulverizing, filtering, leaching, or cacining and other industrial mineral processing techniques to produce high brightness, filler, coating, delaminated, or calcined products.

2. The method of claim 1 wherein the area to be explored extends for 50 miles north of the Fall Line.

3. The method of claim 1 wherein the preferred source rock is a leucocratic, medium to coarse grained peraluminous, biotite.

4. The method of claim 3 wherein the rock is post-metamorphic.

5. The method of claim 4 wherein the rock is granite.

6. The method of claim 1 wherein the kaolin feed of steps 5 and 7 of claim 1 is the feed of the processes of blunging, screening, classifying, magnetically separating and leaching to produce a high brightness filler.

7. The method of claim 1 wherein the kaolin feed of steps 5 and 7 of claim 1 is the feed of the processes of blunging, screening, classifying, magnetically separating and leaching to produce a high brightness coating product.

8. The method of claim 1 wherein the kaolin feed of steps 5 and 7 of claim 1 is the feed of the processes of blunging, screening, classifying, magnetically separating, and calcining to produce a calcined product.

9. The method of claim 6 in which the oversize fraction is used to produce the end product.

10. The method of claim 7 in which the oversize fraction is used to produce the product.

11. The method of claim 8 in which the oversized fraction is used to produce the product.

12. The method of claim 6 in which the oversize fraction of the initial oversize fraction is used to produce the product.

13. The method of claim 7 in which the oversize fraction of the initial oversize fraction is used to produce the product.

14. The method of claim 8 in which the oversize fraction of the initial oversize fraction is used to produce the product.

15. The method of claim 7 in which the product has been ground and classified.

16. The method of claim 8 in which the product has been ground and classified.

17. The method of claim 8 in which the product is produced from the fine fraction.

18. The method of claim 7 wherein the oversize faction is delaminated and classified and the resulting oversize and fine fraction are each magnetically separated and leached to produce product.

19. The method of claim 8 wherein the product of magnetic separation is pulverized and calcined.

20. The product of step 7 of claim 1 wherein the kaolin feed of steps 5 and 7 of claim 1 is the feed of the processes of blunging, screening, classifying, magnetically separating and leaching to produce a high brightness filler.

21. The product of step 7 of claim 1 wherein the kaolin feed of steps 5 and 7 of claim 1 is the feed of the processes of blunging, screening, classifying, magnetically separating and leaching to produce a high brightness coating product.

22. The product of step 7 of claim 1 wherein the kaolin feed of steps 5 and 7 of claim 1 is the feed of the processes of blunging, screening, classifying, magnetically separating, and calcining to produce a calcined product.

23. The product of step 7 of claim 1 wherein the kaolin feed of steps 5 and 7 of claim 1 is the feed of the processes of blunging, screening, classifying, magnetically separating and leaching to produce a high brightness filler in which the oversize fraction is used to produce the end product.

24. The product of step 7 of claim 1 wherein the kaolin feed of steps 5 and 7 of claim 1 is the feed of the processes of blunging, screening, classifying, magnetically separating and leaching to produce a high brightness coating product in which the oversize fraction is used to produce the product.

25. The product of step 7 of claim 1 wherein the kaolin feed of steps 5 and 7 of claim 1 is the feed of the processes of blunging, screening, classifying, magnetically separating, and calcining to produce a calcined product in which the oversized fraction is used to produce the product.

26. The product of step 7 of claim 1 wherein the kaolin feed of steps 5 and 7 of claim 1 is the feed of the processes of blunging, screening, classifying, magnetically separating, and calcining to produce a calcined product in which the oversize fraction of the initial oversize fraction is used to produce the product.

27. The product of step 7 of claim 1 wherein the kaolin feed of steps 5 and 7 of claim 1 is the feed of the processes of blunging, screening, classifying, magnetically separating and leaching to produce a high brightness coating product in which the oversize fraction of the initial oversize fraction is used to produce the product.

28. The product of step 7 of claim 1 wherein the kaolin feed of steps 5 and 7 of claim 1 is the feed of the processes of blunging, screening, classifying, magnetically separating, and calcining to produce a calcined product in which the oversize fraction of the initial oversize fraction is used to produce the product.

29. The product of step 7 of claim 1 wherein the kaolin feed of steps 5 and 7 of claim 1 is the feed of the processes of blunging, screening, classifying, magnetically separating and leaching to produce a high brightness coating product in which the product has been ground and classified.

30. The product of step 7 of claim 1 wherein the kaolin feed of steps 5 and 7 of claim 1 is the feed of the processes of blunging, screening, classifying, magnetically separating, and calcining to produce a calcined product in which the product has been ground and classified.

31. The product of step 7 of claim 1 wherein the kaolin feed of steps 5 and 7 of claim 1 is the feed of the processes of blunging, screening, classifying, magnetically separating, and calcining to produce a calcined product in which the product is produced from the fine fraction.

32. The product of step 7 of claim 1 wherein the kaolin feed of steps 5 and 7 of claim 1 is the feed of the processes of blunging, screening, classifying, magnetically separating and leaching to produce a high brightness coating product wherein the oversize faction is delaminated and classified and the resulting oversize and fine fraction are each magnetically separated and leached to produce product.

33. The product of step 7 of claim 1 wherein the kaolin feed of steps 5 and 7 of claim 1 is the feed of the processes of blunging, screening, classifying, magnetically separating, and calcining to produce a calcined product wherein the product of magnetic separation is pulverized and calcined.

34. The product of step 7 of claim 1 having a brightness gain of more than 10 GEB units as the result of magnetic separation.

35. The product of claim 34 wherein the product has at least an additional 4 GEB units of brightness as the result of leaching.

36. The product of claim 34 wherein the product is a filler clay.

37. The product of claim 34 wherein the product is a coating clay.

38. The product of claim 34 wherein the product is a delaminated clay.

39. The product of claim 34 wherein the product is a calcined clay.

40. The product of claim 34 wherein the product is a high brightness clay.

41. A high brightness clay product produced from a primary crude kaolin from along the northern contact of the Atlantic Coastal Plain, said crude kaolin comprising kaolinite particles having a high aspect ratio, the GE Brightness of said product being at least 10 GE Brightness units greater than said crude kaolin and in excess of 90 GE Brightness units, the L values of said product being in excess of 95, the a value being less than 0.2 and the b value being less than 3.0.

42. The high brightness clay product of claim 41 where the increase in brightness is at least 14 GE Brightness units.

43. A delaminated clay product produced from a primary crude kaolin from along the northern contact of the Atlantic Coastal Plain, said crude kaolin comprising kaolinite particles having a high aspect ratio, the GE Brightness of said product being at least 10 GE Brightness units greater than said crude kaolin and in excess of 90 GE Brightness units, the L value of said product being in excess of 96, the a value being less than 0.1 and the b value being less than 3.0.

44. The delaminated clay product of claim 43 where the increase in brightness is at least 15 GE Brightness units.

45. The delaminated clay product of claim 44 where the increase in the brightness is at least 17 GE Brightness units.

46. A calcined clay product produced from a primary crude kaolin from along the northern contact of the Atlantic Coastal Plain, said crude kaolin comprising kaolinite particles having a high aspect ratio, the GE Brightness of said product being at least 10 GE Brightness units greater than said crude kaolin and in excess of 93 GE Brightness units, the L value of said product being in excess of 97, the a value being less than 0.4 and the b value being less than 2.0.

47. The calcined clay product of claim 46 where the increase in brightness is at least 20 GE Brightness units.

48. A paper product containing the product of claim 41 and having increased sheet brightness, decreased b values, increased opacity and sheet gloss when compared to the same formulation containing a conventional clay.

49. The paper product of claim 48 wherein the sheet brightness is increased at least 2 points.

50. A paper product containing the product of claim 43 and having increased sheet brightness, decreased b values, increased opacity and sheet gloss when compared to the same formulation containing a conventional delaminated clay.

51. The paper product of claim 50 wherein the sheet brightness is increased at least 2 points.

52. A paper product containing the product of claim 46 and having increased sheet brightness, decreased b values, increased opacity and sheet gloss when compared to the same formulation containing a conventional calcined clay.

53. The paper product of claim 52 wherein the sheet brightness is increased at least 2 points.

54. A paint composition containing the product of claim 41 and having improved reflectance and an increased hiding power and opacity when compared to the same formulation containing conventional clay.

55. The paint composition of claim 54 wherein the hiding power is increased on the order of 30% over that the same formulation containing conventional clay.

56. A paint composition containing the product of claim 43 and having improved reflectance and an increased hiding power and opacity when compared to the same formulation containing conventional delaminated clay.

57. The paint composition of claim 56 wherein the hiding power is increased on the order of 30% over that the same formulation containing conventional delaminated clay.

58. A paint composition containing the product of claim 46 and having improved reflectance and an increased hiding power and opacity when compared to the same formulation containing conventional calcined clay.

59. The paint composition of claim 58 wherein the hiding power is increased on the order of 30% over that the same formulation containing conventional delaminated clay.

60. Each and every new, novel, and unobvious feature or combination disclosed herein.
